(19) United States
(12) Patent Application Publication
(10) Pub. No.: US 2021/0209551 A1
(43) Pub. Date: Jul. 8, 2021

(54) SYSTEM AND METHOD FOR AUTOMATIC ANALYSIS AND MANAGEMENT OF A WORKERS' COMPENSATION CLAIM

(71) Applicants: Albert Navarra, Newport Beach, CA (US); Ambika Sapra, Newport Beach, CA (US)

(72) Inventors: Albert Navarra, Newport Beach, CA (US); Ambika Sapra, Newport Beach, CA (US)

(21) Appl. No.: 17/026,434

(22) Filed: Sep. 21, 2020

Related U.S. Application Data
(63) Continuation-in-part of application No. 16/372,739, filed on Apr. 2, 2019.

(51) Int. Cl. G06Q 10/10; G06Q 40/08; G06F 40/216; G06N 5/04

(52) U.S. Cl. CPC G06Q 10/10; G06N 5/04; G06F 40/216; G06Q 40/08

(57) ABSTRACT

A system and method for automatically analyzing information related to a workers' compensation claim and for providing a corresponding case analysis report. A licensed user computer is programmed to upload via a computer network documents and data related to a workers' compensation claim and then to receive a downloaded case analysis report comprising analysis and a recommended plan of action regarding the workers' compensation claim. A server computer is programmed to receive the documents and data related to the workers' compensation claim. The server computer includes programming for a pdf/image text extractor, a checklist data provider, an information identifier, a natural language processor, an issue identifier, an issue analyzer, and a decision data model. The server computer is programmed to generate the case analysis report and to download the report to the licensed user computer.

The present invention relates to systems and methods for managing insurance claims, and in particular, to systems and methods for managing workers' compensation claims. The present invention is a Continuation-in-Part (CIP) of U.S. patent application Ser. No. 16/372,739, filed on Apr. 2, 2019, all of which is incorporated by reference herein.

### BACKGROUND OF THE INVENTION

### Workers' Compensation Insurance

Workers' Compensation is a form of insurance providing wage replacement and medical benefits to employees injured in the course of employment in exchange for mandatory relinquishment of the employee's right to sue his or her employer for the tort of negligence. When there has been an injury on the job and when a claim has been filed, a successful workers' compensation defense strategy is often very expensive for insurance companies and self-insured employers. There can be many documents to sort through and many deadlines to track. Legal issues also need to be considered. Appropriate actions need to be taken.

What is needed is a device and method that makes it easier and less expensive to conduct a successful workers' compensation defense.

### SUMMARY OF THE INVENTION

The present invention provides a system and method for automatically analyzing information related to a workers' compensation claim and for providing a corresponding case analysis report. A licensed user computer is programmed to upload via a computer network documents and data related to a workers' compensation claim and then to receive a downloaded case analysis report comprising analysis and a recommended plan of action regarding the workers' compensation claim. A server computer is programmed to receive the documents and data related to the workers' compensation claim. The server computer includes programming for a pdf/image text extractor, a checklist data provider, an information identifier, a natural language processor, an issue identifier, an issue analyzer, and a decision data model. The server computer is programmed to generate the case analysis report and to download the report to the licensed user computer.

### BRIEF DESCRIPTION OF THE DRAWINGS

FIG. 1 shows computer connectivity of a preferred embodiment of the present invention.

FIGS. 2-8 show a flowchart depicting a preferred embodiment of the present invention.

FIGS. 9-72 show features of another preferred embodiment of the present invention.

### DETAILED DESCRIPTION OF THE PREFERRED EMBODIMENTS

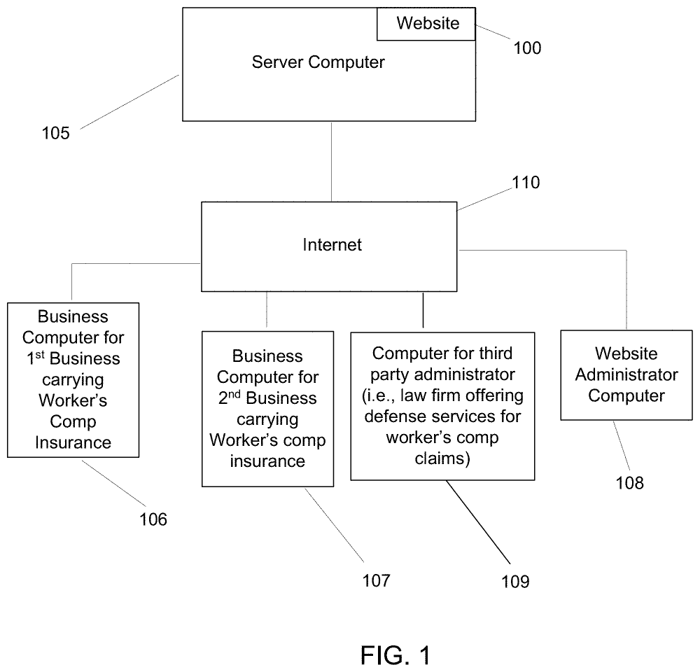

FIG. 1 shows a preferred embodiment of the present invention. The present invention allows for automated, simplified tracking and analysis of the facts and issues associated with a workers' compensation claim. In a preferred embodiment, a licensed user purchases access to software that allows the licensed user to track an ongoing or potential workers' compensation claim. Licensed user's may be a business that carries workers' compensation insurance. Or a licensed user may be a third-party administrator that monitors various workers' compensation claims. An example of a third-party administrator may be a law firm that specializes in workers' compensation defense. The system shown in FIG. 1 allows for licensed user to track, analyze and take appropriate action on workers' compensation claims as they occur.

FIG. 1 shows an example of a preferred embodiment of the present invention. An employer carrying workers' compensation insurance has purchased an account allowing the business to use business computer 106 to access website 100 via the Internet. Business computer 106 may be a personal computing device such as a laptop computer, a cell phone, and iPhone® or an iPad®. Access to website 100 allows the insurance carrier to analyze and process potential workers' compensation claims and active workers' compensation claims as they may occur. Likewise, a second business utilizes business computer 107 for the same purpose. In a similar fashion, a law firm specializing in workers' compensation defense utilizes computer 109 to access website 100 via the Internet for the same purpose.

An administrator for website 100 monitors all connectivity via website administrator computer 108.

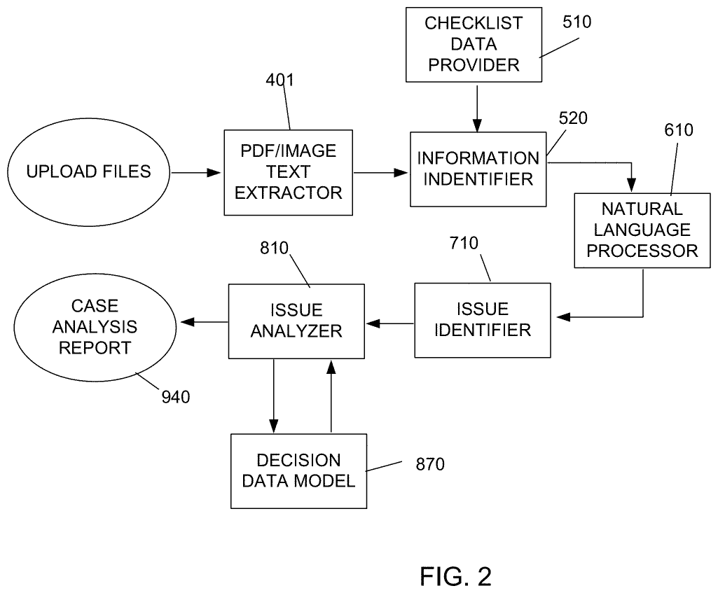

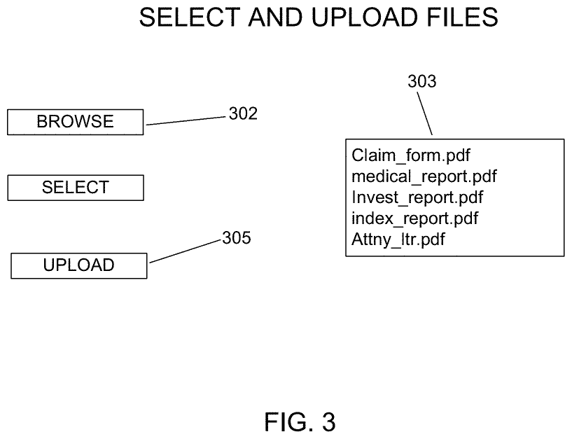

In a preferred embodiment of the present invention, website 100 is loaded onto server computer 105. Website 100 includes programming outlined by the flowchart depicted in FIG. 2 and described in greater detail in FIGS. 3-8.

In FIG. 3, the user has utilized computer 106 to log onto website 100 via the Internet. The user has clicked button 302 to browse the database on computer 106 (FIG. 2). The user has then selected files important to an ongoing workers' compensation claim. These files are displayed in display box 303 and include pdf files of the claim form, the medical report, the investigative report, the index report and the letter from opposing attorney who filed the claim. Once the claims are selected, they can be uploaded by clicking button 305.

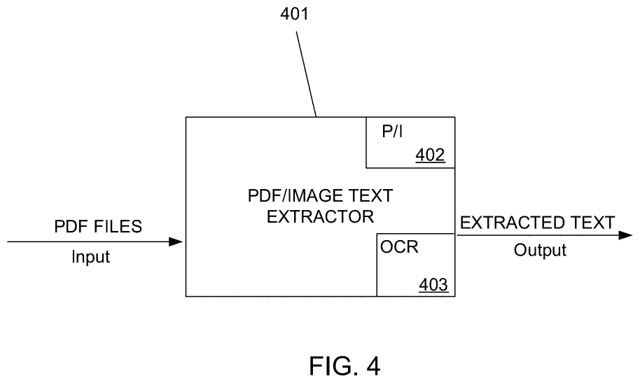

As shown in FIG. 2, after the pdf files have been uploaded to website 100, they will be modified via a pdf text extractor module 401 (FIG. 4). PDF text extractor 401 (FIG. 4) includes two parts. The first part is PDF to image converter 402. Converter 402 converts all the pages in the uploaded pdf files are converted to individual image files. Optical character recognition (OCR) tool 403 is then utilized to extract text from the individual image files.

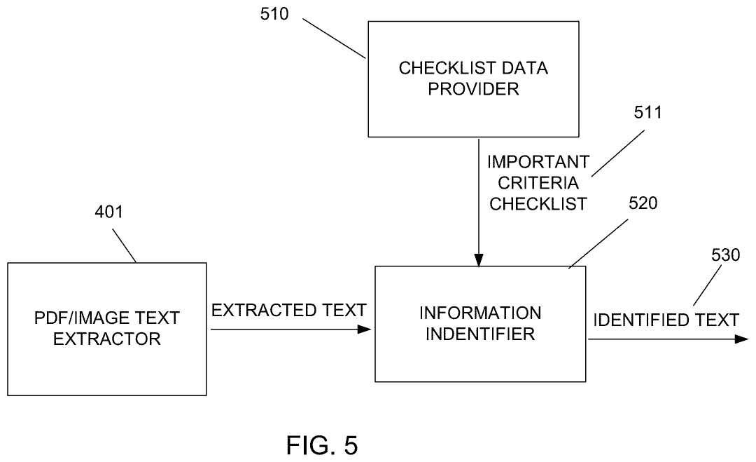

Extracted text is output from pdf text extractor 401 (FIG. 4) and is input into information identifier 520 (FIG. 5). Additionally, checklist data provider 510 inputs important workers' compensation claim criteria checklist 511 into information identifier 520. In a preferred embodiment, workers' compensation claim checklist 511 includes information that is important to the analysis of a workers' compensation claim. An item from checklist 511 is picked and its corresponding information is identified from the extracted text. Information identifier 520 identifies all possible information related to checklist 511 and presents as an output identified text 530.

For example, in one preferred embodiment “Date Claim Filed” is a checklist item included in checklist 511 to be identified from the extracted text. Information identifier 520 identifies all the possible information from the extracted text related to the claim date. Output leaving information identifier 520 is identified as identified text 530, which includes all the possible dates which could be the claim date.

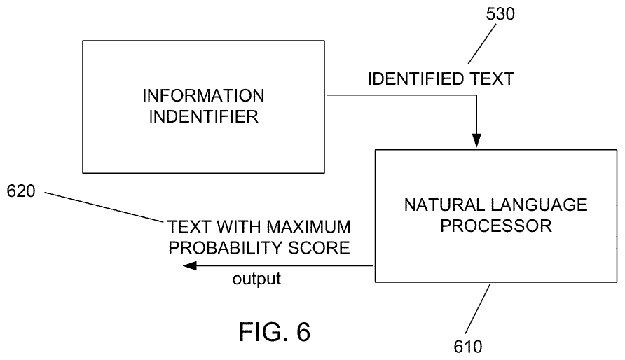

Identified text 530 is output from information identifier 520 and is input into natural language processor 610 (FIG. 6). Natural language processor includes programming to analyze identified text 530 and gives a probability score to each identified text. The identified text with the maximum probability score will be chosen as the required information.

For example, the date that has the maximum probability score will be chosen as the ‘claim date’ in the workers' compensation claim and this date will be used for further analysis. The text with the maximum probability score 620 is output from natural language processor 610.

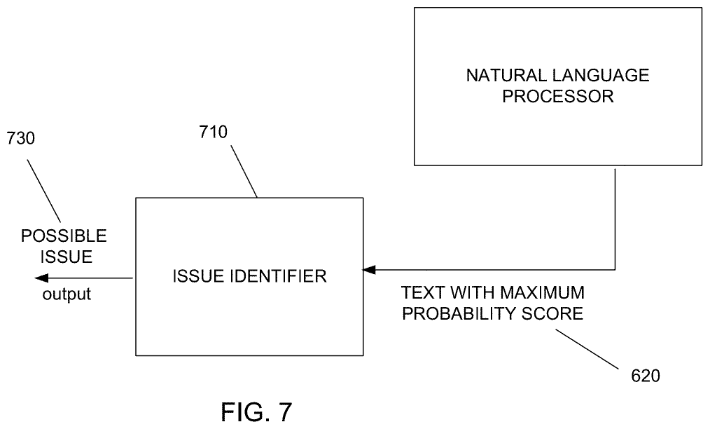

In FIG. 7, the text with maximum probability score 620 is input into issue identifier 710. Issue identifier 710 includes programming that checks the maximum probability score 620 with checklist 511 (FIG. 5) to identify issues that the input text 620 could be linked to. The output from issue identifier 710 is possible issue 730.

For example, in a preferred embodiment issue identifier receives input text 620 that is ‘claim date’. After checking ‘claim date’ input text 620 with checklist 511, issue identifier identifies a possible issue as ‘90-day decision deadline’, which is a deadline that is triggered as a result of reporting an injury for a potential workers' compensation claim.

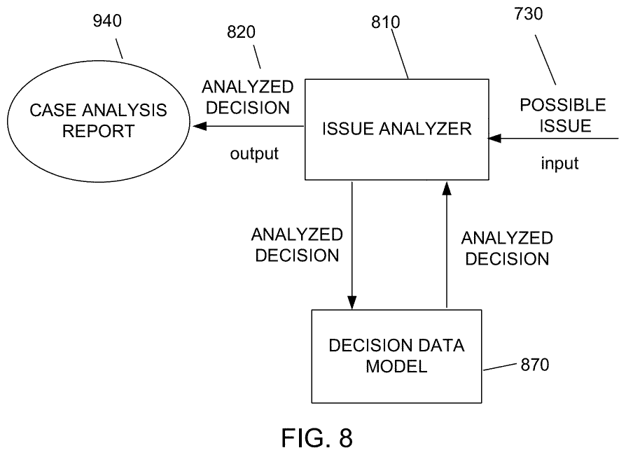

In FIG. 8, possible issue 730 is input into issue analyzer 810. Issue analyzer 810 includes programming that will analyze possible issue 730 utilizing parameters stored in checklist 511 (FIG. 5) and arrive at a decision. Analyzed decision 840 is output to decision data model 870 and to case analysis report 940.

For example, in a preferred embodiment issue analyzer 810 analyzes the issue of '90-day decision deadline with the following parameters established in checklist 511:
1. “Is the current date less than or more than 60 days from when the claim was filed?”
2. “Is the current date less than or more than 90 days from when the claim was filed?”

If the current date is less than 60 days from when the claim was filed, issue analyzer 810 includes programming to accept the checklist item and output analysis decision 840 that accepts the checklist item and issue a warning that alerts the user to the approaching 90-day deadline.

If the claim was filed 90 days after the date of injury (DOI) the checklist item will be rejected. The decision with evidence will be shown on case analysis report 940. Issue analyzer 810 then checks for other checklist items to gather more evidence for a detailed report.

If the claim was before 90 day from the DOI the checklist item will be accepted. The decision with evidence will be shown on case analysis report 940. Issue analyzer 810 then checks for other checklist items to gather more evidence for a detailed report.

Also in FIG. 8, analyzed decision 840 is input to decision data model 870. Decision data model 870 will store analyzed decision 840 with evidence for the respective checklist item. The decision will be stored for future purposes.

For example, the decision with respect to the claim date will be stored for future purposes. Accordingly, issue analyzer 810 could potentially skip steps in its analysis after directly retrieving information from past analysis from decision data model 870 with regards to claim date. Machine learning programming is included in decision data model 870 allowing for issue analyzer 810 to continuously improve efficiency with the number of claim documents it reads and analyzes.

After completed, analyzed decision 840 is downloaded to the user's computer to form case analysis report 940. Case analysis report 940 includes the information about all items in checklist 511. Report 940 includes the following for all items in checklist 511:
1. Decision (whether accepted or rejected)
2. Detailed evidence (reason for acceptance or rejection)

For example, the first item checklist 511 (Date Claim filed) is the first item on case analysis report 940. The decision and its evidence is shown:
1. If the claim was filed 90 days after the date of injury (DOI) the checklist item will be rejected. The decision with evidence will be shown on case analysis report 940. The evidence is the Date of the Claim and the Date of the Injury.
2. If the claim was before 90 day from the date of injury (DOI) the checklist item will be accepted. The decision with evidence will be shown on case analysis report 940. The evidence is the Date of the Claim and the Date of the Injury.

The device and method depicted in FIGS. 1-8 provides a tremendous benefit to licensed users. After comparison to criteria from checklist 511, data is extracted from the files uploaded by the licensed user. The data is analyzed to identify legal issues, analyze the issues and recommend action plan through downloadable case analysis report 940.

Benefits of the above described method and device include:
1. Accurate factual assessment of the case. A human acting alone may miss information, or record information incorrectly. However, the above describe method and device is accurate to a very high degree relative to humans.
2. Thorough identification of legal issues and defenses. A human being may miss issues and have incomplete or inaccurate beliefs about the law and how it applies to cases. The program has a very high degree of thoroughness and accuracy compared to humans.
3. The program implements a highly successful and efficient litigation strategy. “Breaking the Habit”® is a federally registered trademark owned by Sapra & Navarra, LLP, and the mark refers to “legal services, namely, providing legal defense for employers and insurance companies in workers' compensation cases.” The “Breaking the Habit”® strategy reduces average total cost per case and average cycle time (length of time case is open) by 67% for seven straight years. These results have been confirmed by the leading actuarial company in the California. In a preferred embodiment, checklist 511 is compiled in accordance with criteria consistent with the “Breaking the Habit”® strategy. Analysis and recommended actions are therefore conducted and presented in a fashion that is consistent with the “Breaking the Habit”® strategy.

### Other Preferred Embodiment

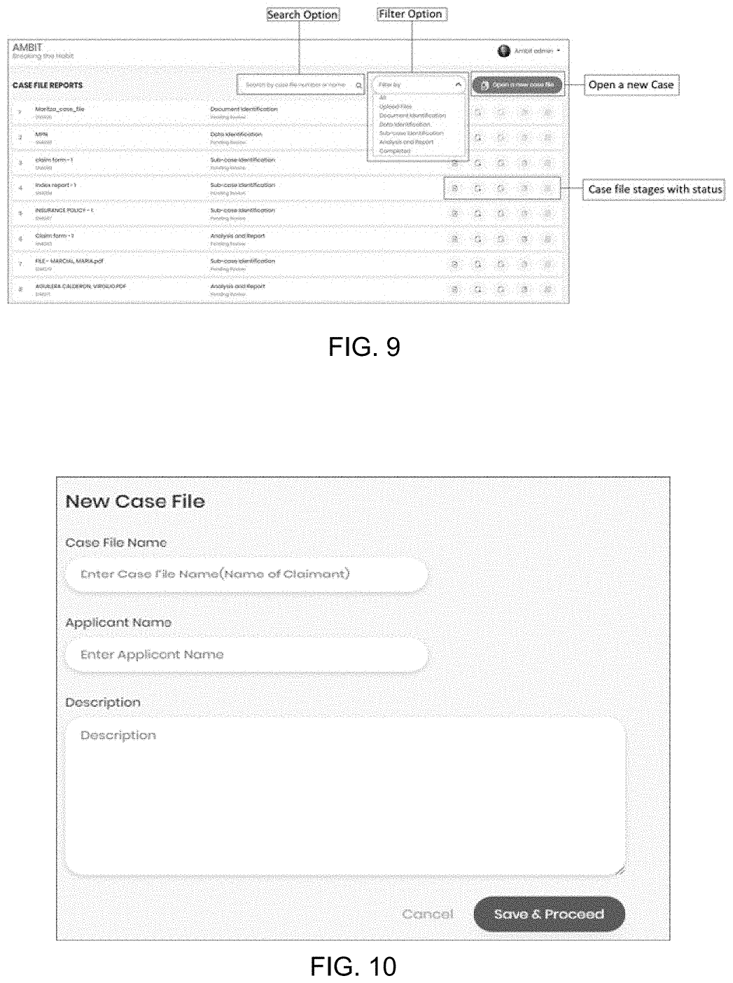

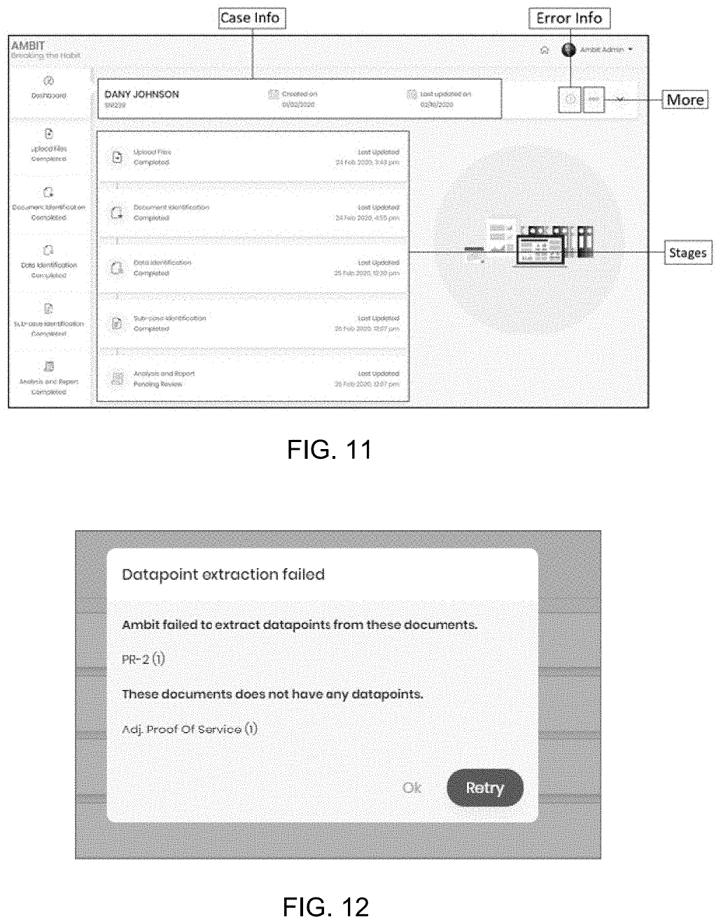

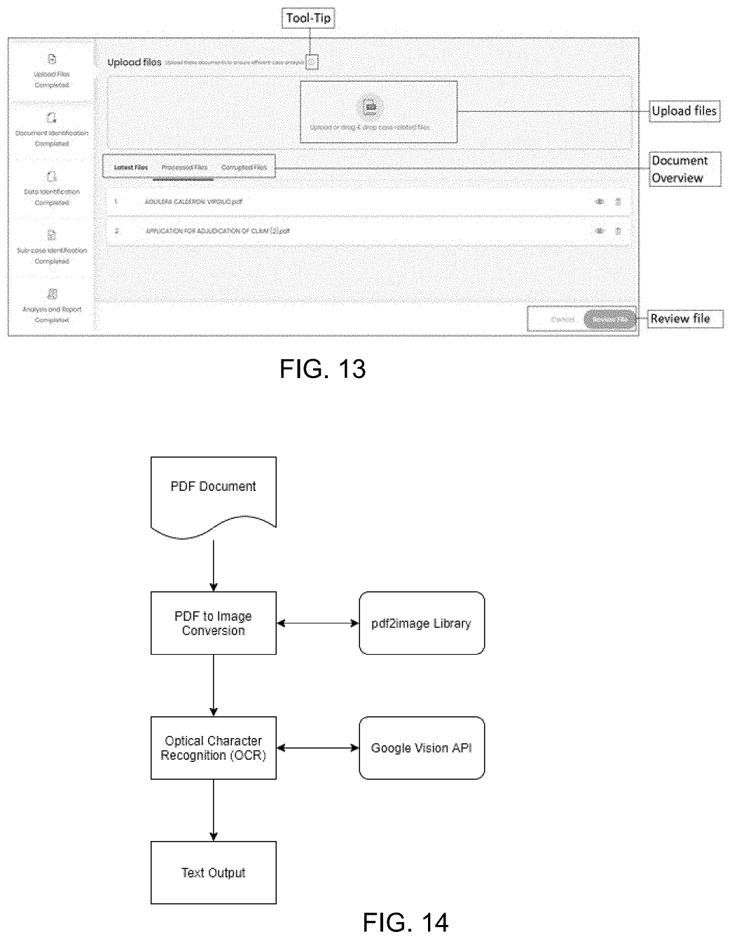

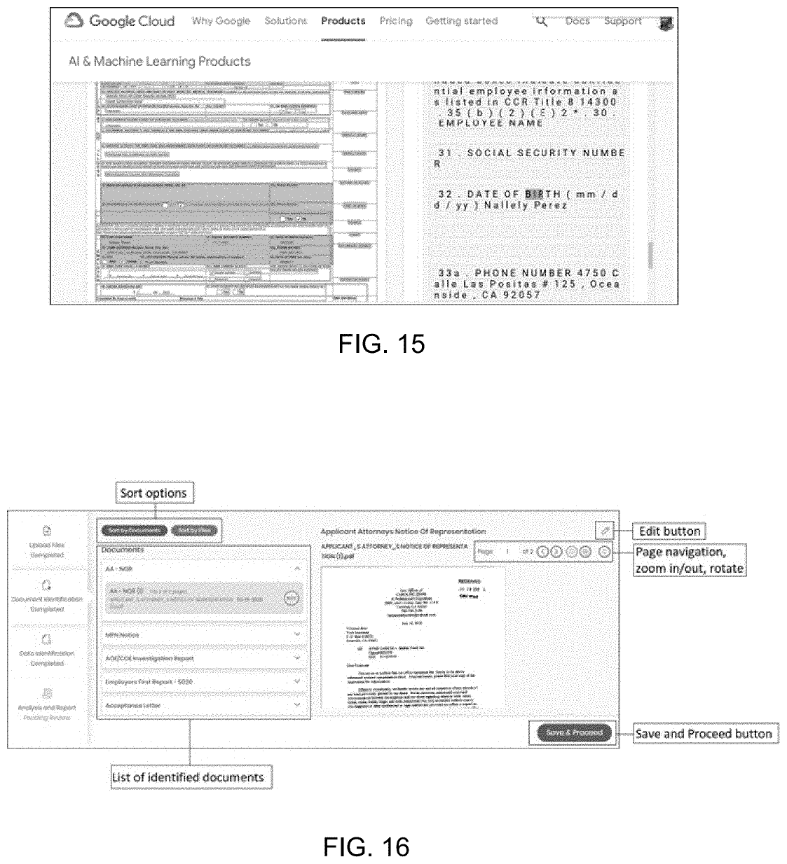

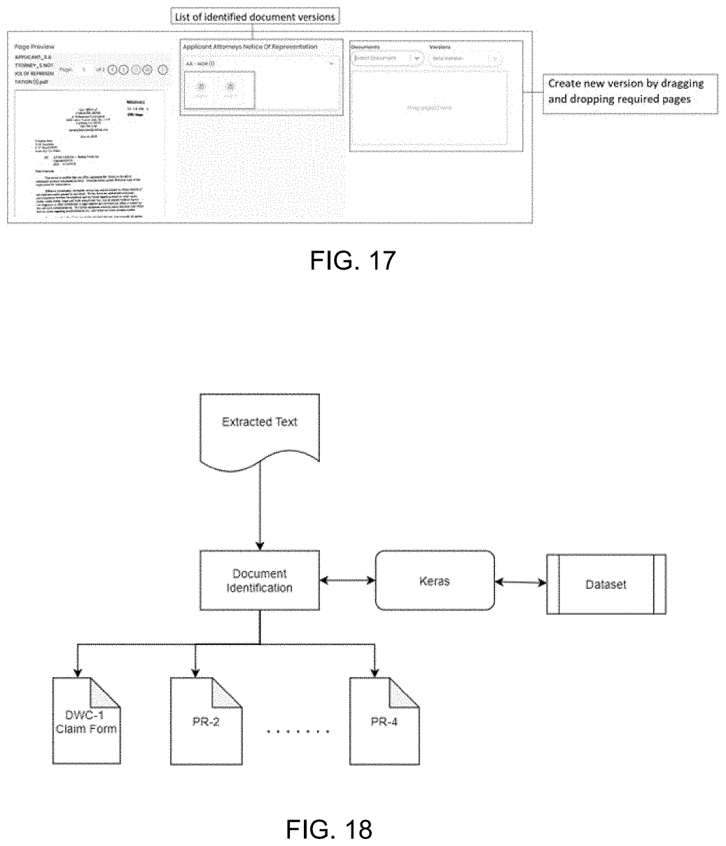

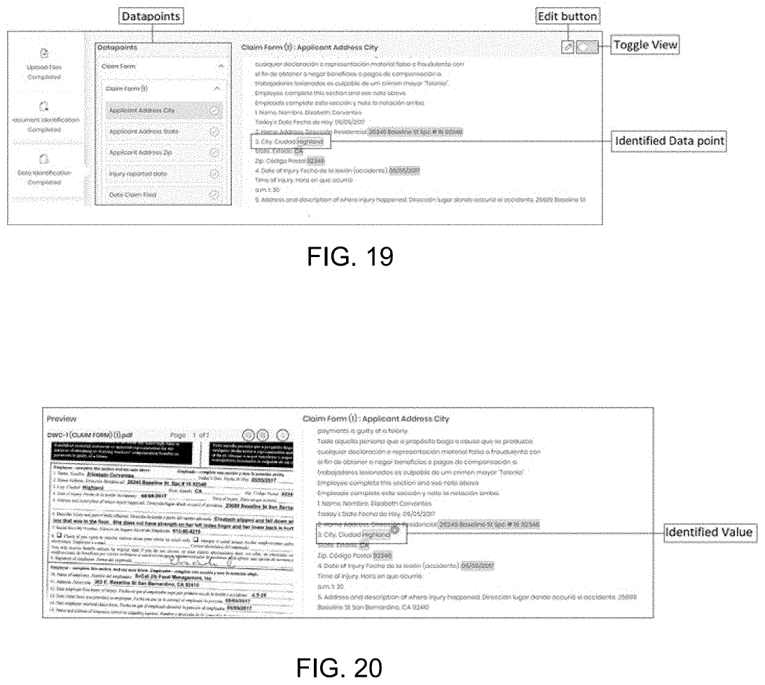

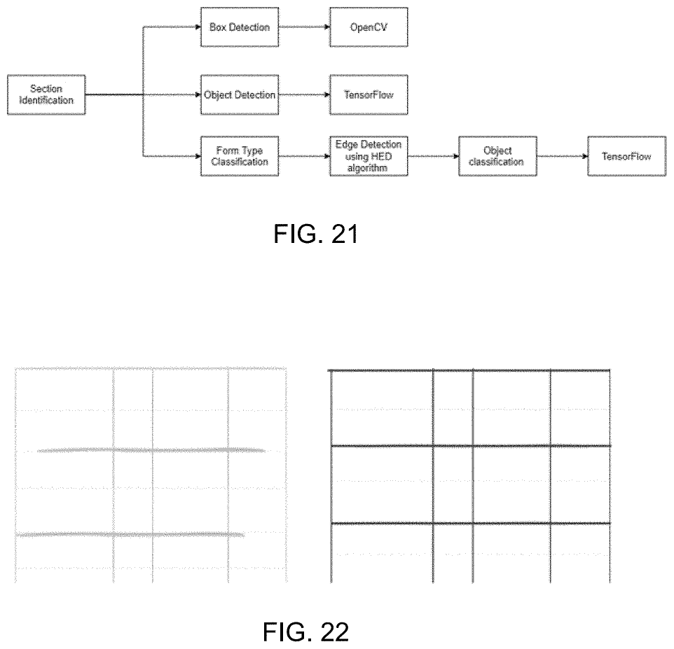

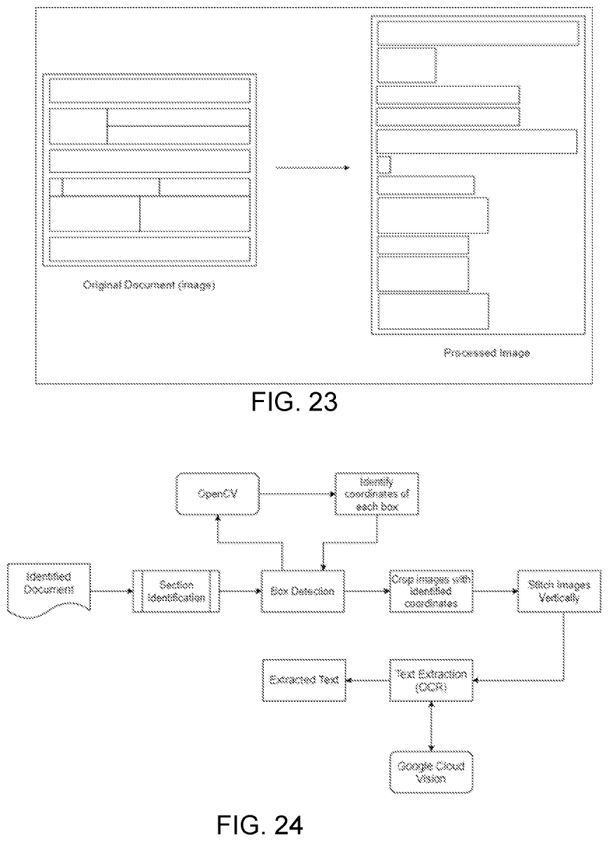

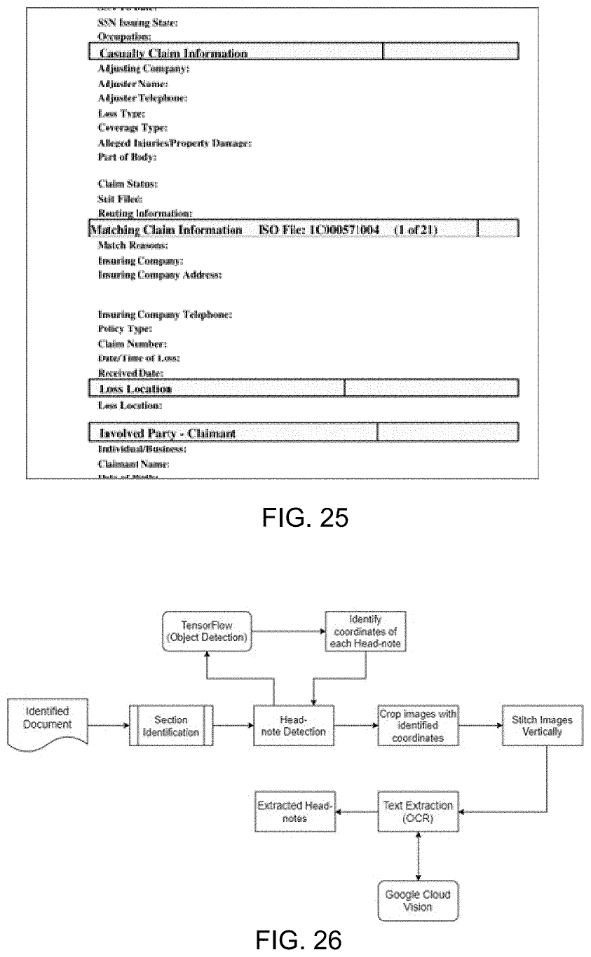

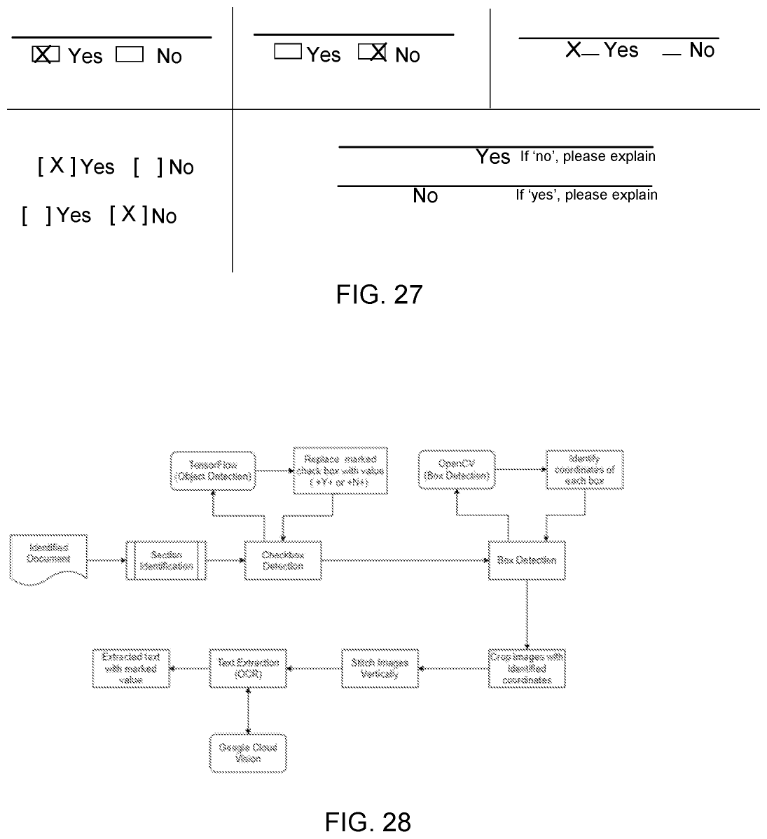

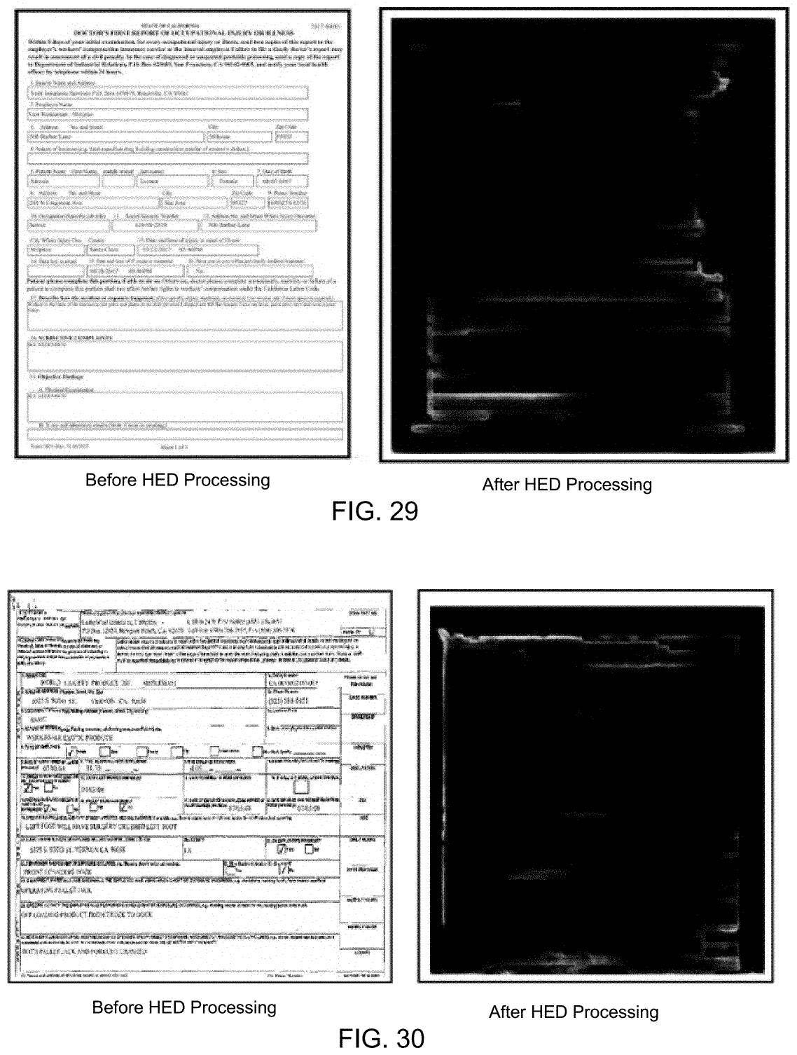

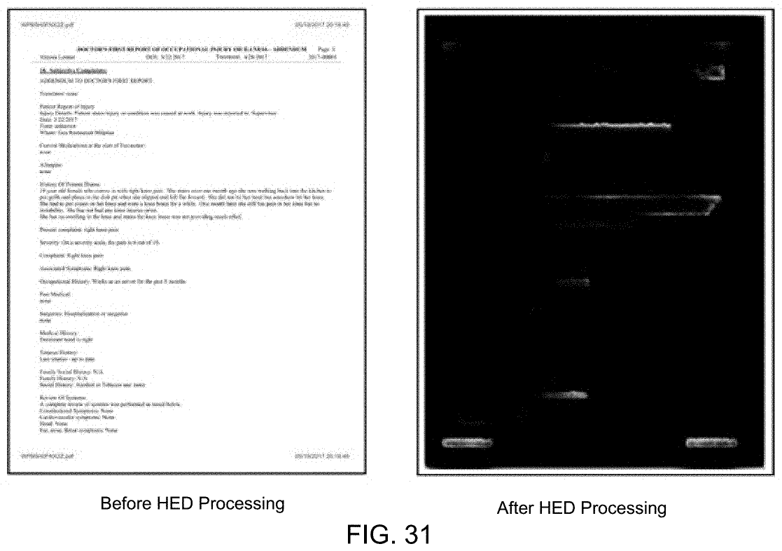

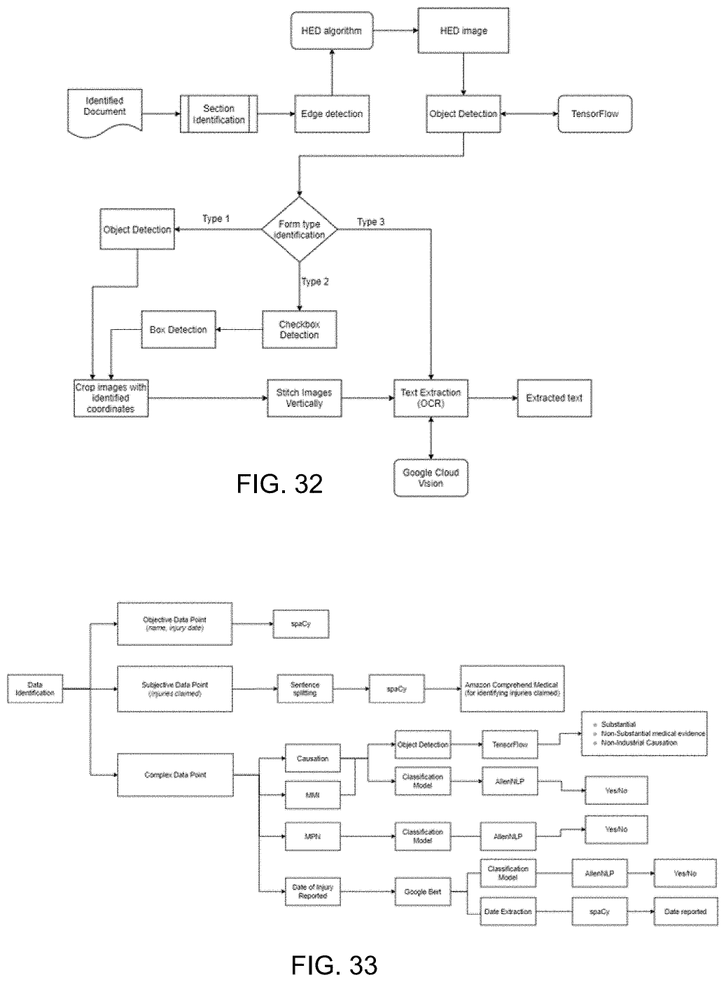

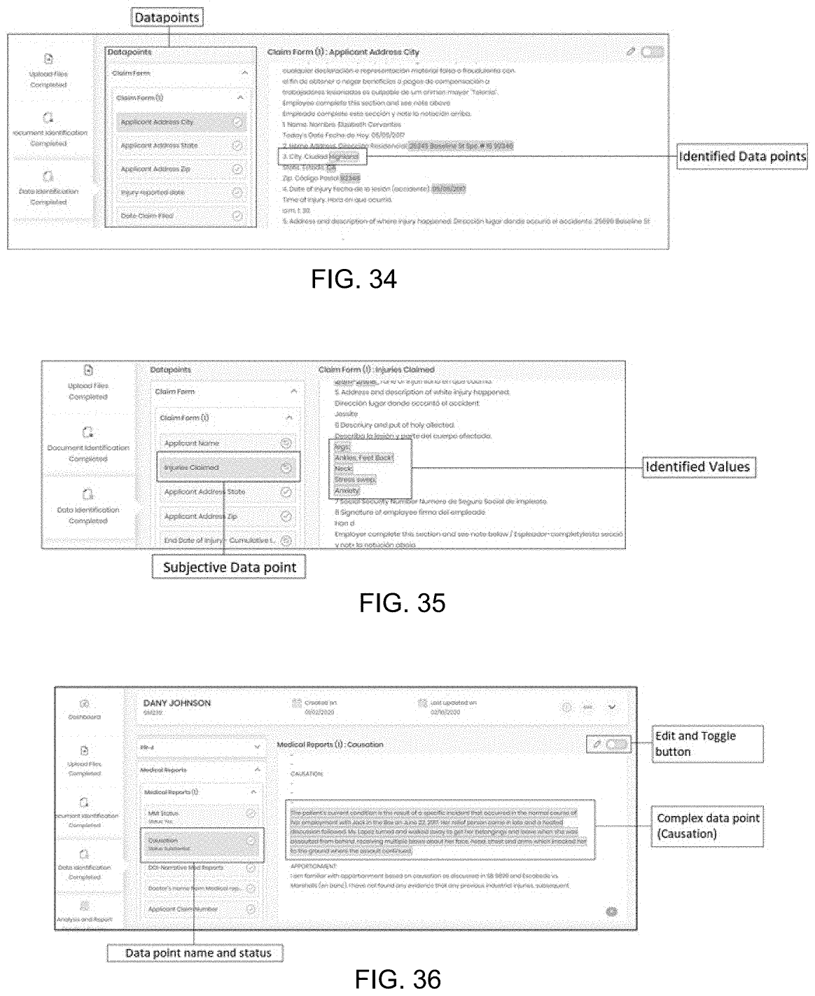

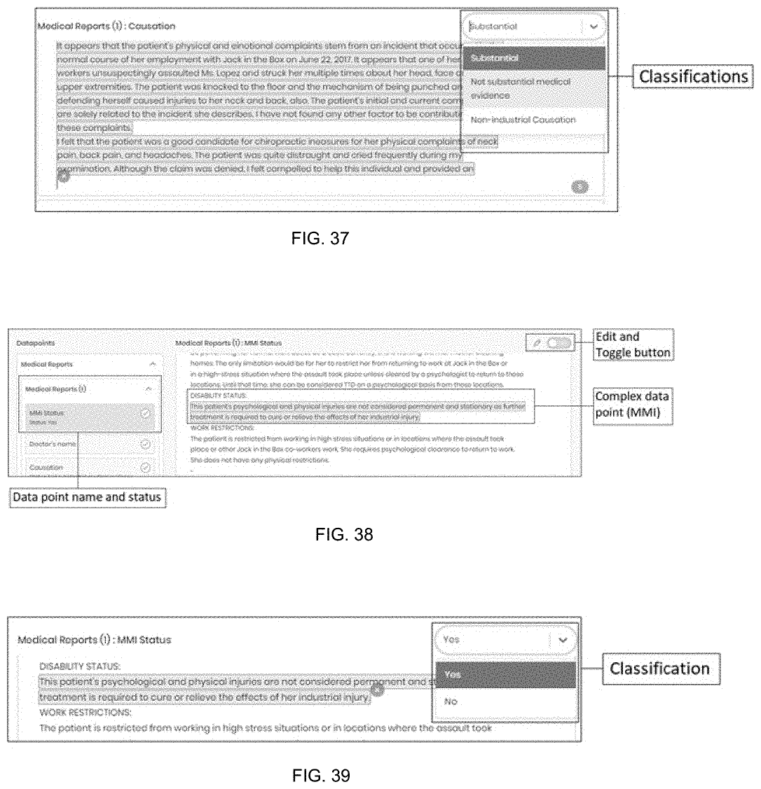

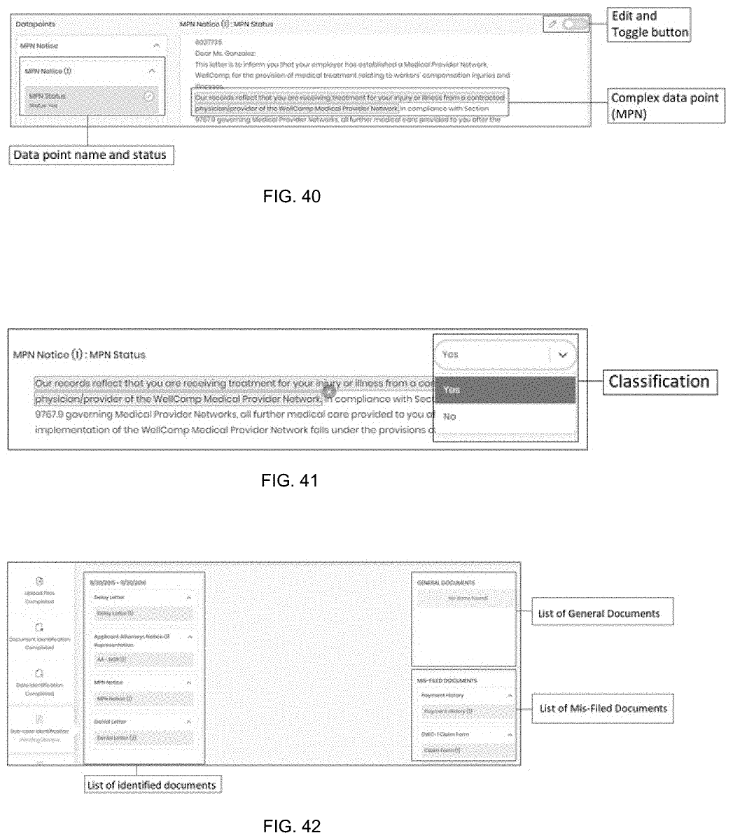

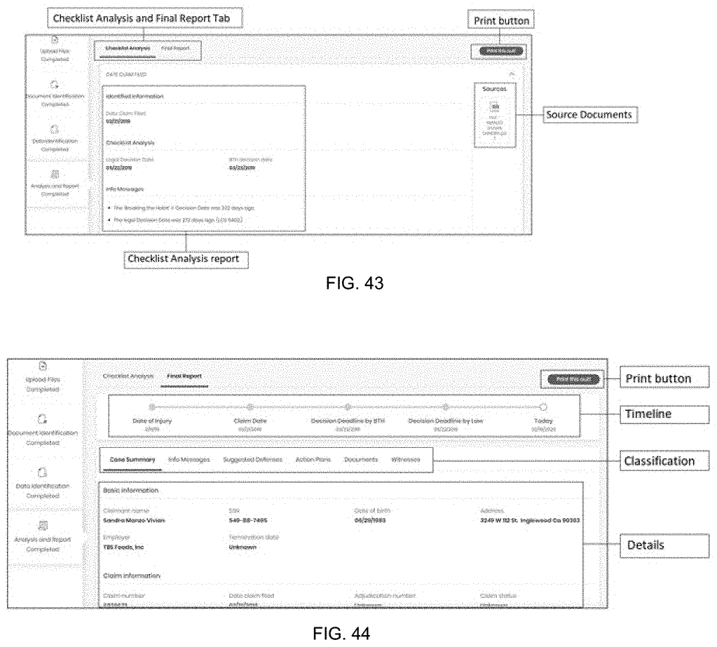

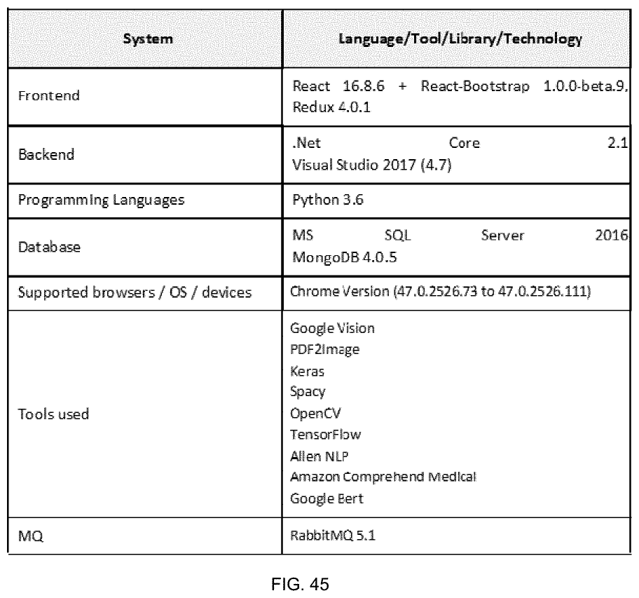

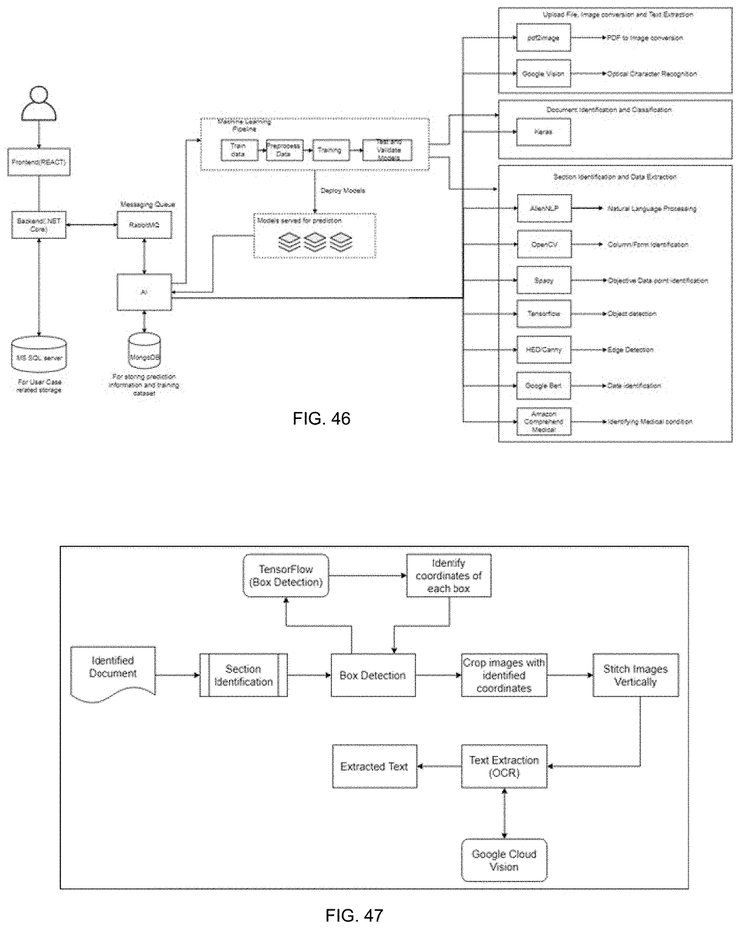

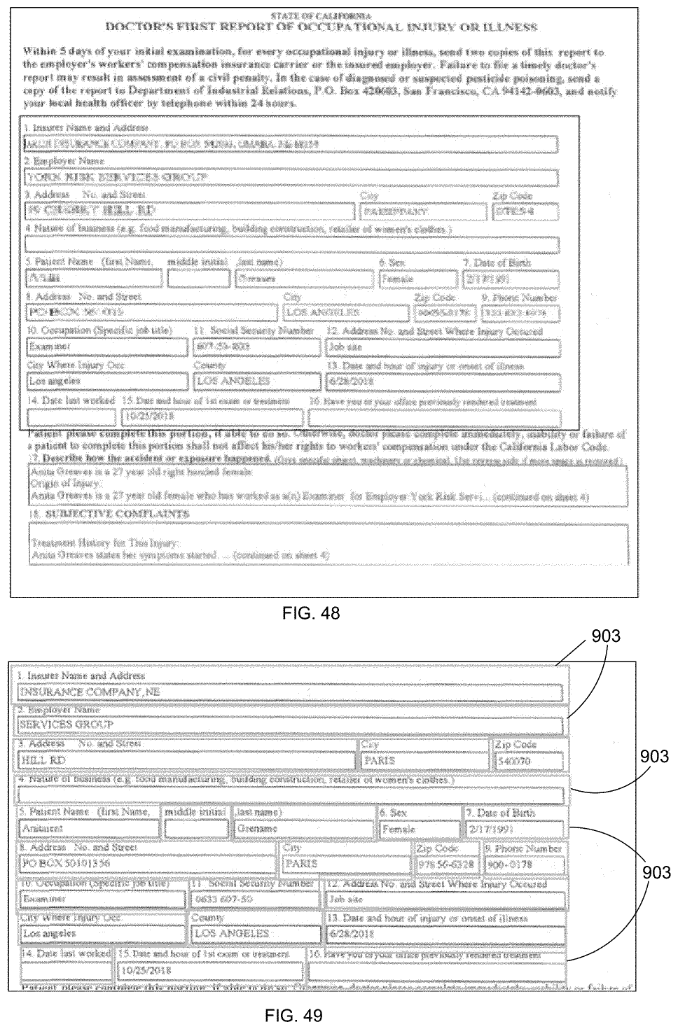

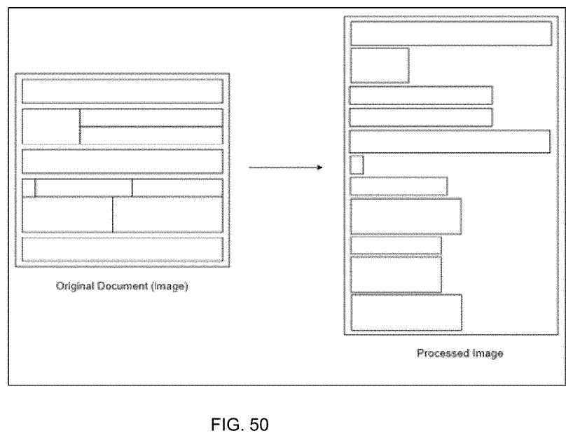

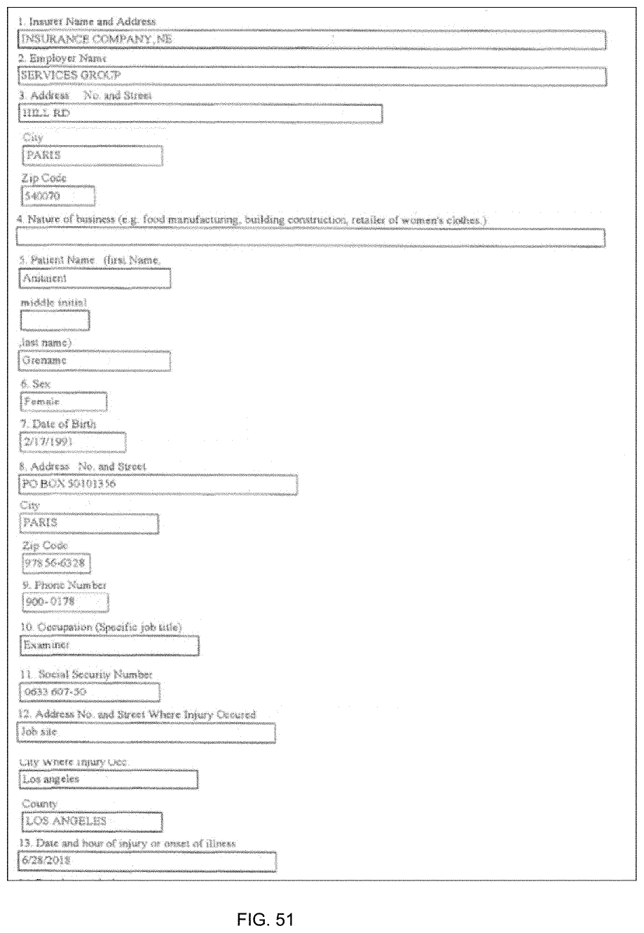

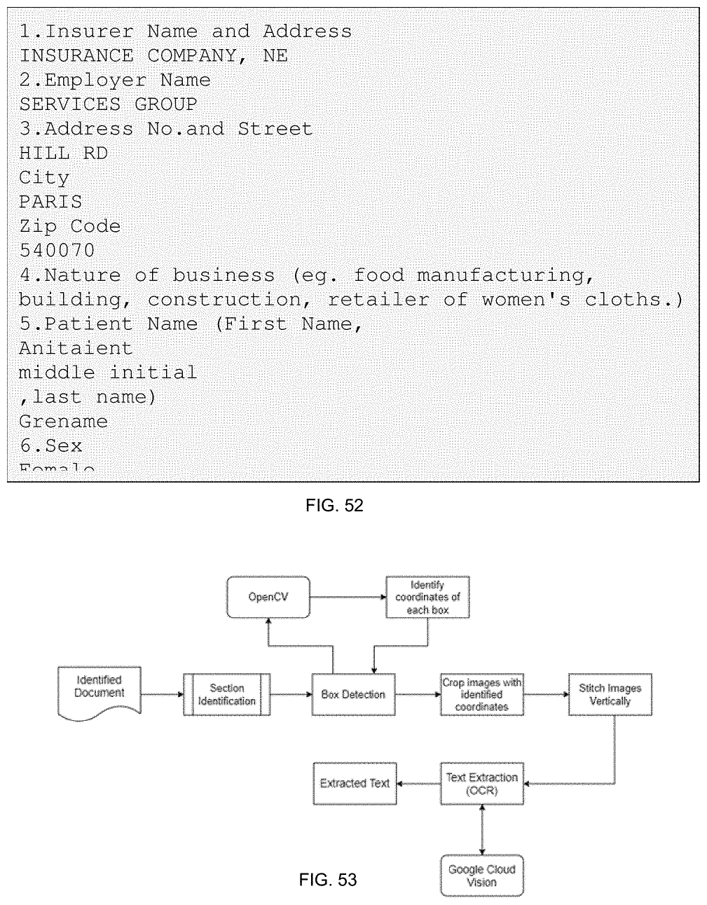

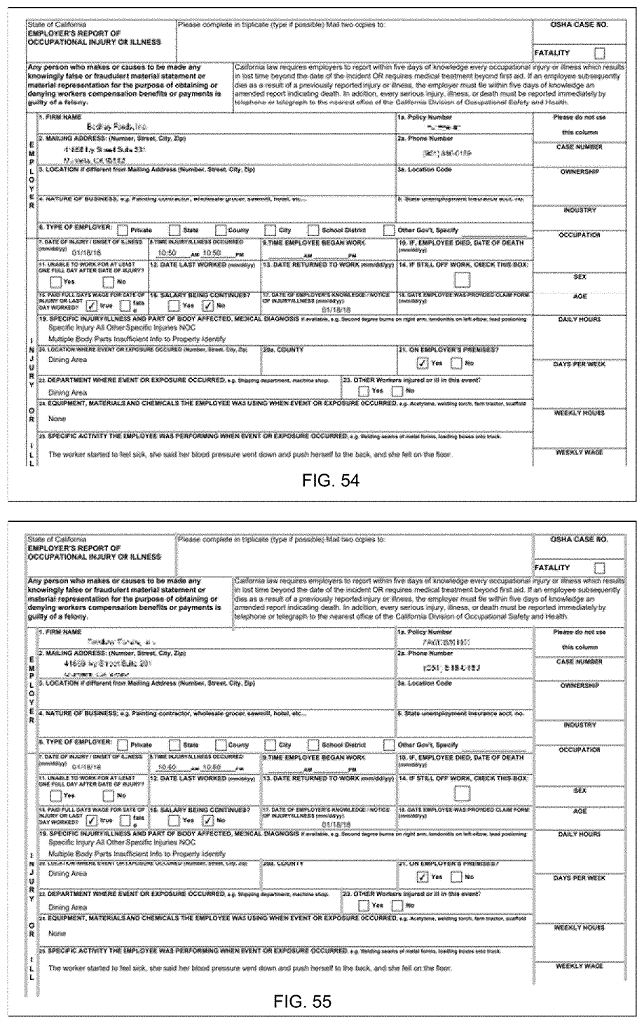

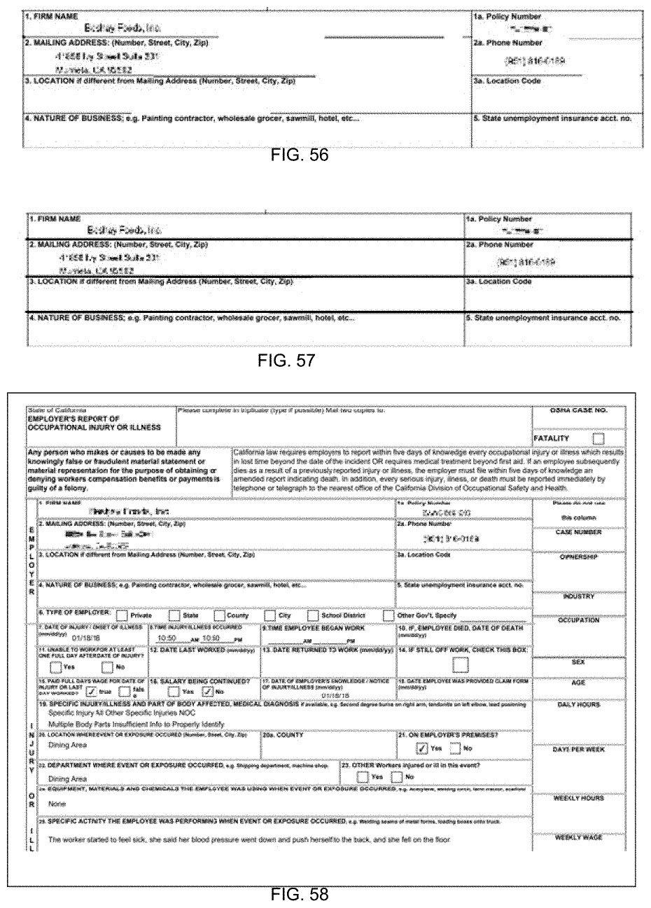

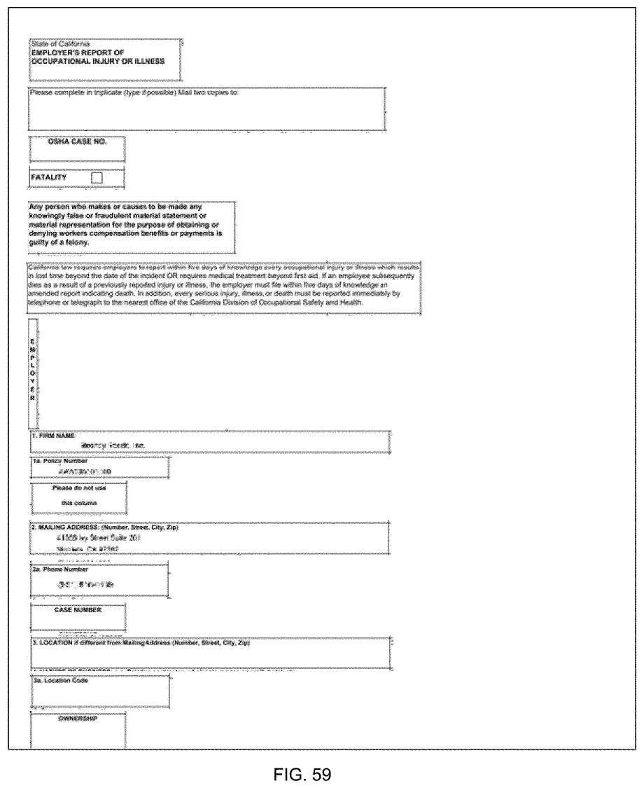

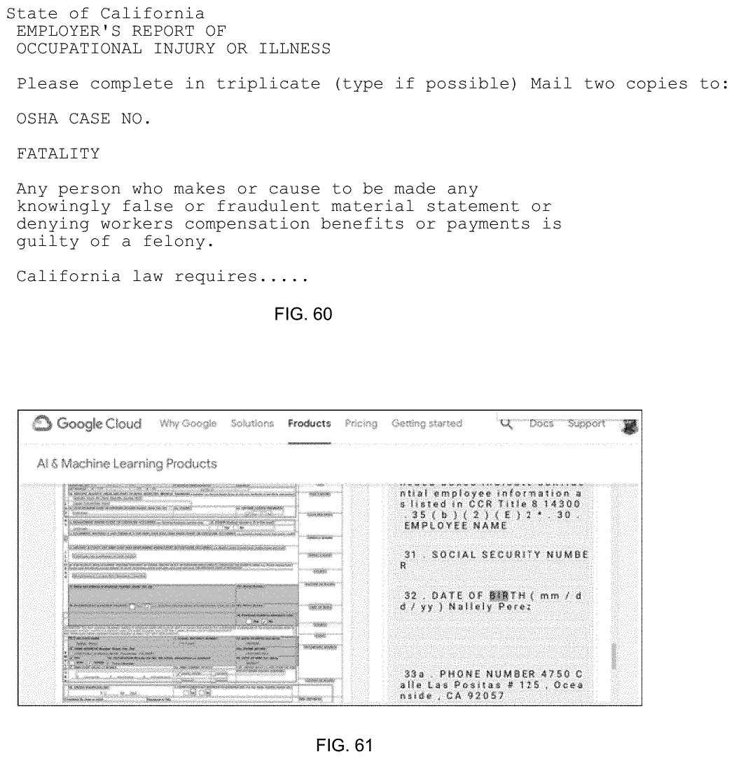

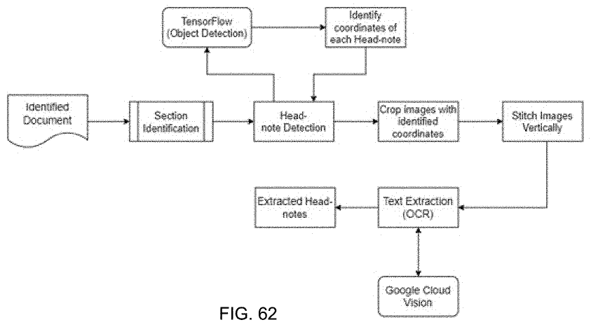

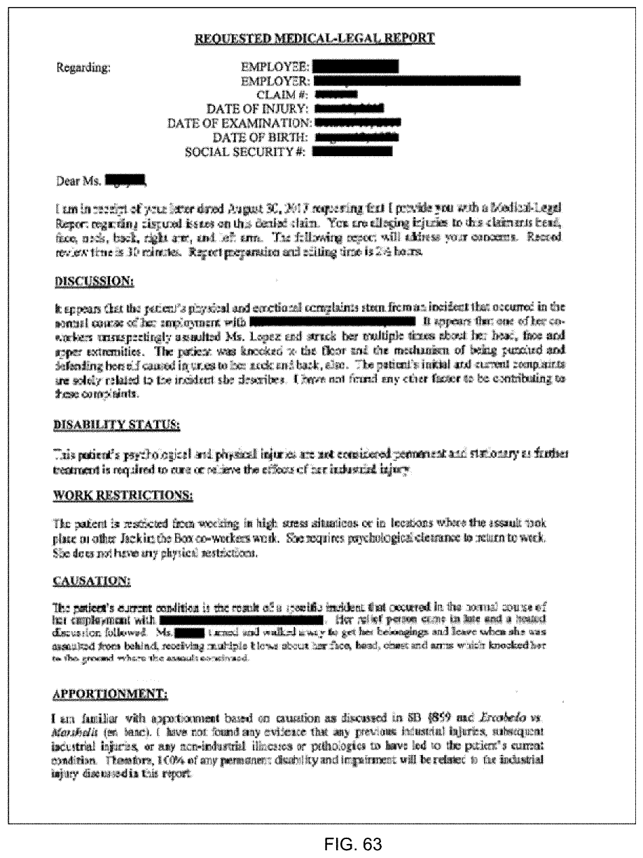

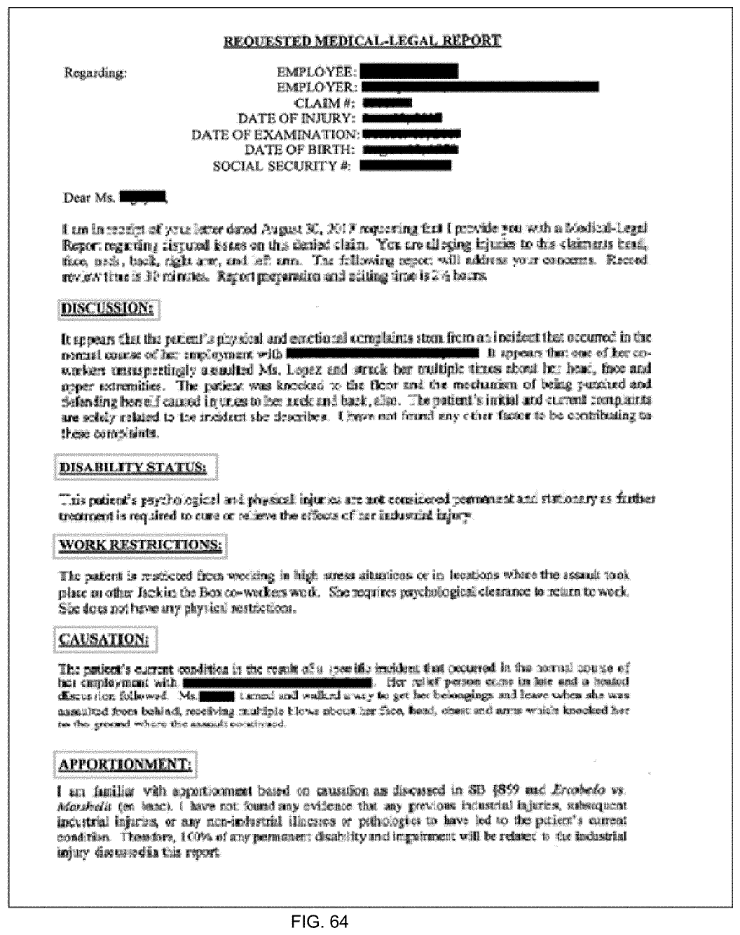

FIG. 9 shows the home page of another preferred embodiment of the present invention. In this preferred embodiment, website 100 includes programming to extract data from single or multiple documents, analyze the data using checklist 511 and then displays the result as output. The main modules available in the application are:
Home Page
Dashboard
Upload Files
Document Identification
Data Identification
Subcase Identification
Analysis and Report

Home page (FIG. 9) is the landing screen displayed when a user is signed into the application. This page displays the list of all case files in the system. The case files are sorted by the last modified on top by default.

The details in the list include:
Name of the case file (with case file ID)
Current stage and the status
An Interactive graphical representation of the current stage and status of the case file.
Users can navigate to the individual stage of the selected case file by selecting the icons representing each stage.

### Search Option

This option allows the user to search a case file with the name or number and have live search as user types in.

### Filter Option

The filter option can be used to filter the case file reports list either by the stage (Upload Files, Document Identification, Data Identification, Sub-case Identification, Analysis and Report and Completed) or all case files.

### Open New Case File

On clicking the “Open a new case file” button, users will be redirected to the new case file screen (FIG. 10) where the user can open a new case file by providing the basic details like Case file name (preferably the name of claimant), Applicant name and Description (optional).

### Dashboard

Dashboard (FIG. 11) is specific to each case file and gives an overview of the different stages in the case. The dashboard is displayed on clicking the dashboard menu after selecting a case from the main screen.

Information displayed in Dashboard includes case file name, case-id, applicant name, Number of identified sub-cases, Case created date, Last updated date, description and a timeline showing the different stages and their current status.

### Error Info

The error info icon on the top corner shows additional information regarding any failure in the case. Error scenarios include:

1. Failing to extract data points from any document

2. Documents without any data points

Clicking on the error info icon will display a summary of the error scenarios (FIG. 12).

### Action

The action button has options to edit or delete a case file.

### Stages of Case File

The dashboard also displays the different stages of a case file along with the current status and the last updated date. Users can navigate to the stages by clicking on the respective tabs.

### Upload Files

The user can upload all the case related documents from the page shown in FIG. 13. In a preferred embodiment, the supported format is pdf.

### Tool-Tip

A tool-tip icon is provided for the user which has the list of documents that are required for efficient case analysis.

### Upload Files

The documents can either be uploaded to the website 100 or be dragged and dropped to the specified location in the application.

### Files Overview

Document Overview (FIG. 13) gives an overview of all the Files that have been uploaded for this case file and classifies the files uploaded as:
Latest files: Lists the latest uploaded files. These files can be verified and edited at this stage if the user already knows the documents that are present in the respective files. This also helps training the AI better to identify the documents. This is mentioned in detail in the “Document Identification” section.
Processed files: Files that are already processed will be listed here and the user can view or delete the files.
Corrupted files: Files which are corrupted/not processed will be listed here and the user can retry uploading these kinds of files.

Website 100 considers the following files as corrupted:
Documents other than .pdf or .docx
Password protected documents
Documents with Invalid PDF structure

### Review File

Once the documents are uploaded, users can either cancel or proceed to review the document.

The user can upload additional documents while existing documents are being processed. However, the entire case processing would be re-initiated while doing this.

### Key Features

Once the user clicks on ‘Review File’, the uploaded files will be processed for identifying different documents (FIG. 14).

The scanned pdf documents are converted to images and then processed using Optical Character Recognition (OCR) tool for text extraction. The extracted text is then processed using AI Deep learning algorithms to identify the different documents present in the files.

### PDF to Image Conversion

Google Cloud Vision OCR tool processes images as input files and website 100 needs the files in image format for further extraction of data like Headnotes, checkboxes etc.

Therefore, the uploaded PDFs are converted to images first and then sent for text extraction.

### Tool Used: pdf2image

In a preferred embodiment, website 100 uses a pdf2image library for converting PDF to image files. Pdf2image is a python library that acts as a wrapper around the pdftoppm command line tool to convert pdf to a sequence of PIL* image objects.

PIL is a free library that adds image processing capabilities to a Python interpreter, supporting a range of image file formats such as PPM, PNG, JPEG, GIF, TIFF and BMP. PIL offers several standard procedures for image processing/manipulation, such as: pixel-based manipulations.

### Text Extraction (Optical Character Recognition)

Text will be then extracted from the converted images using an Optical Character Recognition (OCR) tool/software. Optical character recognition (OCR) is the conversion of images of typed, handwritten or printed text into machine-encoded text, whether from a scanned document or a photo of a document from subtitle text superimposed on an image, for example.

### Tool Used: Google Vision

In a preferred embodiment, Google Vision API is used for extracting text from an image uploaded.

### Input File Format

The Vision API can detect and transcribe text from Image files, PDF and TIFF files stored in Cloud Storage Images. The Cloud Vision API also supports the following image types: JPEG, PNG8, PNG24, GIF, Animated GIF (first frame only), BMP, WEBP, RAW, ICO.

### Limitations

Text detector reads randomly by assigning boxes in the image and there are possibilities that it returns text in a different sequence from the original text sequence. This issue happens mainly in form-based documents.

FIG. 15 shows an example of the limitation with Google Vision for a form-based document. Here, the date of birth is followed by the employee name instead of actual date and the phone number field shows address as the corresponding value.

### Statuses

The upload file stage (FIG. 13) can have four different status depending on the documents being processed and they are:
Not started—When the documents are not yet uploaded.
In Progress—Documents are being uploaded and not reviewed.
Error—Invalid document or unable to process document.
Completed—When the documents are uploaded and the next stage has started.

### Document Identification

Document Identification is the process of identifying and classifying the uploaded files into different categories of documents.

In a preferred embodiment website 100 is trained to identify around 67 different types of documents.

These are classified into 3 different types:

1. Documents with Data Points: These are documents from which Website 100 would be extracting different data points in order to analyze the case file using the Breaking The Habit checklist.

E.g: DWC-1 Claim Form (see Table A below)

2. Documents without Data Points: These are documents which are required to analyze the Breaking The Habit checklist. However, Website 100 does not extract any data points from these documents.

E.g: 1099 Form (see Table A below)

3. Invalid Documents: These are documents which are trained to improve the accuracy of Website 100 to identify the Documents.

E.g: Document Coversheet (see Table B below)

TABLE A

| | |
|---|---|
| Documents with data points | Documents without data points |
| DWC-1 Claim Form | 1099 Form |
| Application for | Application For Adjudication - |
| Adjudication | Proof Of Service |
| Applicant Attorneys | Declination of |
| Notice Of Representation | claim form |
| Employer's First Report - 5020 | Declination of Medical Treatment |
| Doctor's First Report - 5021 | Earnings Statement |
| Insurance Policy | Employee Handbook |
| Payment History | Employers Incident Report |
| | or Accident Report |
| Referral Fetter | Employment Application or |
| | Application for Employment |
| AOE/ COE Investigation Report | Fee Disclosure |
| Index (ISO) Report | I-9 |
| Acceptance Letter | Job Description |
| Delay Letter | Performance Reviews |
| Denial Letter | Prior Matching Claims |
| Narrative Medical Reports | SubPoena Records |
| PR-2 | Termination Notice |
| | or Separation Notice |
| PR-4 (Discharge Report) | Time Card Statements |
| WCIRB Report | W-2, W-4, W-9 |
| MPN Notice | Work Status Report |

Invalid Documents
Answer to Application For Adjudication
Application For Adjudication - Proof Of Service
Compromise & Release
Declaration Of Readiness to Proceed
Defense Attorney (Sapra & Navarra) Notice Of
Representation
Defense Exhibits
Document Cover Sheet
DocumentSeparator
E-Cover sheet
EAMS
Fee Disclosure
Guide to Workers Compensation Medical Care
Health Insurance Claim
Initial File Review
Letters from Carrier/TPA
Litigation Budget Plan
Mileage Rates
Notice and Request for allowance of Lien
Notice of Hearing
Periodic File Review
Physician Return to Work & Voucher Report
Policy Holder Notice
Pre-trial statement
Proof of Service
Request For Authorization
Request for Qualified Medical Evaluator Panel
Stipulations with Request for Award
WCAB Resolution of Liens

The scanned pdf documents are processed through OCR for text extraction. The extracted text is then classified as different documents using Deep learning techniques.

The Deep learning techniques uses a pre-trained dataset that has samples of different document types and this helps in identifying the respective documents from the uploaded files. A new entry will be added to the dataset of a document type every time a human verifies the programmed prediction output.

### Reviewing Documents

All the identified documents are listed on the left side (FIG. 16) as accordions where users will be able to see multiple versions (if any) on expanding the accordion.

The documents are classified into different sections such as:

a. Documents: All the documents for which there is a confidence percentage of more than 70% are listed in this section.

b. Ambiguous identifications: All the documents for which there is a confidence percentage of less than 70% are listed in this section.

c. Invalid Documents: Invalid Documents are the documents from which data could not be extracted for the case analysis. Website 100 is preferably programmed to train on identifying the documents so that the likelihood for misidentifying these documents as one of the valid document types is avoided.

d. Other Documents: All documents/pages which website 100 could not categorize as an existing document type are listed in this section.

The documents identified will be displayed as a list with the document name as heading (see FIG. 16). The list also shows the accuracy and confidence of the identified document in percentage.

### Training AI

Website 100 accepts feedback from users for learning and improvement of document identification. If the user identifies that a document is misclassified, the user has an option to classify the document correctly by using the edit option on top right corner (see FIGS. 16-17).

For example, if a DWC-1 Claim Form was mispredicted as another document (possibly because it is a new version or due to the similarity in the content), users can use the edit option to re-classify this as a DWC-1 Claim Form.

This document will be added to the dataset of DWC-1 Claim form and Web site 100 will be trained using the updated dataset so that Website 100 predicts it better the next time.

### Key Features

For document identification and classification, website 100 preferably uses Keras neural network library (FIG. 18). Keras is a high-level open-source neural networks API, written in Python and capable of running on top of TensorFlow, CNTK, or Theano.

The main advantages of using Keras are:
To enable fast experimentation with deep neural networks
It focuses on being user-friendly
Modular and extensible.

Keras is trained to identify each document that is relevant for a case analysis using different samples for each document type. These samples are stored in their respective document dataset and a deep learning model is built using this dataset.

Once the user edits the output, the dataset is updated during the manual review process.

The updated dataset is then used to train the Deep Learning model and this increases the accuracy of document identification based on the user's inputs.

### Statuses

In a preferred embodiment, the Document Identification stage can have five different statuses:
Not started: When the document identification has not been started.
In progress: Document identification process is in progress
Pending Review: When the document identification is completed and not reviewed by the user.
Error: If the process has failed due to any unexpected error.
Completed: When the document identification process is completed and reviewed.

### Data Identification

During the Data Identification process (FIG. 19), data is extracted individually from each of the documents that are identified in the document identification stage.

### Reviewing Data Point—Data Points Listing

All the identified documents will be listed as separate accordions with the list of data points extracted from them.

On clicking a datapoint, website 100 highlights the value of the identified datapoint and is displayed to the user in the extracted text (FIG. 19) for review.

A warning message is displayed if website 100 fails to find a value for the data point in a document.

The user would need to manually tag and highlight the value in such cases to help website 100 predict better.

### Toggle Button

The user also has an option to toggle between the extracted text and the actual document (pdf view) to cross verify the data.

### Training

The user (trainer) has an option to train website 100 by clicking the edit button on top right. In the edit screen, users can see the actual pdf on the left and the extracted text with values of the data points highlighted on the right. (See FIG. 20).

Users have the option to

1. Clear the identified value by clicking on the close button

2. Highlight a new section in the document to tag the value

This will help website 100 to learn the location of the datapoint value in the document that was highlighted by the user. On saving, the edited section will be added as an entry in the datapoint dataset.

Data Identification stage is mainly classified into two steps as:
Section identification
Data identification

### Section Identification

Section identification is the initial step performed before website 100 can process the document for data identification. The input documents that website 100 receives can be of various types and formats which makes the data extraction process difficult. Website 100 uses various libraries for section identification.

### Box Detection

Unlike a plain text document, some of the documents could be of forms or tables with different height and width for rows and columns which makes it difficult for the OCR to detect the data sequentially and generates irrelevant output.

The Box detection method is used to identify whether a form has boxes and identify each box separately. In one preferred embodiment, website 100 is programmed to use OpenCV for box detection.

For some documents where the margins are not clearly visible, OpenCV has difficulties in detecting boxes. In such cases, website 100 extends the margin line so that it crosses the border to form a proper box and can be identified by OpenCV. (FIG. 22)

### Tools Used for Box Detection: OpenCV, Google Vision

OpenCV library has algorithms to identify boxes and can be trained to identify them more accurately by marking them. Once the boxes are marked and identified, website 100 splits the boxes and merges them vertically before resending it to the OCR for text extraction (FIGS. 23 and 24).

### Headnote Detection

Headnote detection is another method website 100 uses for identifying the headnotes separately in documents. Some documents (FIG. 25) will classify the data under different sections separated by headings and it is crucial for website 100 to identify and mark the headnotes for data classification and identification. In a preferred embodiment, website 100 uses object detection methods for identifying the headnotes using TensorFlow.

In a preferred embodiment, website 100 uses Tensor flow Object Detection API for detecting headings from the image document and the model being used is Faster R-CNN Inception v2 architecture.

Website 100 captures the height and width of characters and compares with other characters to differentiate the headnote and non-headnotes. Website 100 considers a word as a headnote if the word matches the predefined heading criteria. Web site 100 can be trained by marking the headnote and capturing the properties such as height, width, Xmin, Xmax, Ymin, Ymax will be saved as a .csv file for reference.

### Checkbox Detection

Object detection method is used to detect the checkboxes in a document and to identify whether the checkbox is checked or unchecked. The various types of checkboxes that are identified are shown in FIG. 27.

### Tool Used: TensorFlow

In a preferred embodiment, website 100 uses object detection methods for identifying the checkbox using TensorFlow. In a preferred embodiment, website 100 is being trained to identify more different types of checkboxes.

When a checkbox is detected as marked, Website 100 replaces the marked checkbox with ‘+Y+’ or ‘+N+’ and a column will be created along with the associated text and will be sent for text extraction. FIG. 28 shows a flowchart depicting the utilization of checkbox detection.

### Edge Detection and Document Type Classification

Edge detection is an image processing technique for finding the boundaries of objects within images. It works by detecting discontinuities in brightness. Edge detection is used for image segmentation and data extraction. FIG. 32 shows a flowchart depicting the utilization of checkbox detection.

### Tool Used: HED

Website 100 is programmed to use HED (Holistically-Nested Edge Detection) algorithm for edge detection and object classification using TensorFlow for different document type classification. Currently it is being used for Doctor's first report to differentiate the three different types of form (Type1 (FIG. 29), Type2 (FIG. 30) and Type3 (FIG. 31)).

### Preferred Tools/Libraries Used

### OpenCV

OpenCV (Open Source Computer Vision Library) is an open source computer vision and machine learning software library. The library has optimized algorithms which includes a comprehensive set of both classic and state-of-the-art computer vision and machine learning algorithms.

### TensorFlow

TensorFlow is a free and open-source software library for dataflow and differentiable programming across a range of tasks. It is a symbolic math library and is also used for machine learning applications such as neural networks.

The TensorFlow Object Detection API is an open source framework built on top of TensorFlow that makes it easy to construct, train and deploy object detection models.

### HED

Holistically-Nested Edge Detection (HED) helps in finding the boundaries of objects in images and was one of the first applied use cases of image processing and computer vision. It works by detecting discontinuities in brightness. Edge detection is used for image segmentation and data extraction.

In order to identify the different types and data formats, various methods are used like Box detection, Heading detection, Checkbox detection and Edge detection.

### Data Identification

Once the sections in a document are identified and classified, the document can be processed for data identification. The data points that are to be identified from any document are classified into Objective, Subjective and complex data points (FIG. 33).

### Objective Data Point

Objective data points are observable and measurable data obtained through observation, physical examination, and laboratory and diagnostic testing. Examples for objective data include name, age, injury date, injury type etc. For identifying objective data points, website 100 is programmed to use custom NER (Named-Entity Recognition) and leverages spaCy (an open-source software library) for advanced natural language processing and extraction of information.

For example, in FIG. 34, City is considered as an objective data point and website 100 identifies Highland as the identified value for the city.

### Tool Used: spaCy

spaCy is an open-source software library for advanced natural language processing, written in the programming languages Python and Cython. spaCy is a preferred tool to prepare text for deep learning and it interoperates seamlessly with TensorFlow. spaCy can be used to construct linguistically sophisticated statistical models for a variety of NLP problems.

Website 100 uses custom NER(Named-Entity Recognition) and leverages spaCy for data identification by advanced natural language processing capability and extraction of information.

### Subjective Data Point

Subjective data points are information from the client's point of view (“symptoms”), including feelings, perceptions, and concerns obtained through interviews. Subjective data type is more descriptive type and can be of more than one sentence. Example of subjective data is description of an injury. Compared to objective type, subjective data points are more difficult to interpret.

Website 100 uses sentence splitting technique with the help of spaCy NLP and can be trained by marking the sentence. Website 100 stores the sentence before and after as the start and end position of the marked sentence.

In FIG. 35 Injuries claimed is a subjective data point. The values can be either mentioned as points, list or could be within a paragraph and website 100 uses Amazon comprehend medical service for identifying the injured body part and the score for the same.

### Tool Used: Amazon Comprehend Medical

Amazon Comprehend Medical is a natural language processing service that makes it easy to use machine learning to extract relevant medical information from unstructured text. Using Amazon Comprehend Medical, information can be gathered quickly and accurately, such as medical condition, medication, dosage, strength, and frequency from a variety of sources like doctors' notes, clinical trial reports, and patient health records.

### Complex Data Point

A complex data point could be a combination of both objective and subjective data. Unlike objective and subjective data points, complex data points are more complicated to interpret.

Website 100 is required to analyze a text content (sentence/paragraph) and leverage the Artificial intelligence capabilities to understand the context of the content and predict the inference just like a human would do. Examples are identifying the outcome of a sentence as positive or negative (yes/no), identifying meaningful data from a paragraph etc.

As per the current implementation, four different data points are identified which use combinations of different approaches to get the desired result. The different data points are:
Causation
MMI
MPN
Date of Injury reported

### Causation

This data point is to identify if the treating physician has stated and verified that the causation of the applicant's injury is industrial. This is a datapoint which provides the user of website 100 information on how well the physician is sure about the causation of the injury.

The datapoint lies in a paragraph with possible headnotes as Causation, Discussion, Assessment in documents like AOE/COE report which could be around 30 pages long.

Website 100 uses a combination of different approaches to identify the datapoint from different documents. Documents from which Website 100 identifies this datapoint are

A. AOE/COE Report

B. D-5021

C. Treating Doctors Medical Report

D. PR-2

Headnote detection is used to identify the different headnotes from the 30 page long document. Once all the headnotes are identified, website 100 will search for the headnotes which could have the causation content and start labelling the text after a matching headnote is found. The labelling ends at the very next headnote, thus being able to label the entire paragraphs in which causation is being mentioned by the treating physician.

The extracted text is then sent to Text Classification model built using AllenNLP where the model is pre-trained with samples of content for each of the categories:
Substantial
Non-Substantial medical evidence
Non-Industrial Causation

The classified data will be displayed as the status under Causation (FIG. 36).

### Training

If the classification seems to be incorrect, the user has an option to train website 100 by clicking the edit button on top and on the training page, the user will have an option to select the correct classification from a dropdown (FIG. 37).

### Tools Used: TensorFlow, AllenNLP

AllenNLP is an open-source NLP research library, built on PyTorch. It provides a framework that supports modern deep learning workflows for cutting-edge language understanding problems. AllenNLP uses spaCy as a preprocessing component.

Website 10 uses the Elmo model of AllenNLP to interpret a sentence and to identify whether it is a positive or negative statement.

### Elmo Model

ELMo is a deep contextualized word representation that models both complex characteristics of word use (e.g., syntax and semantics), and how these uses vary across linguistic contexts (i.e., to model polysemy).

These word vectors are learned functions of the internal states of a deep bidirectional language model (biLM), which is pre-trained on a large text corpus. They can be easily added to existing models and significantly improve the state of the art across a broad range of challenging NLP problems, including question answering, textual entailment and sentiment analysis.

### MMI

Maximum Medical Improvement(MMI) data point (FIG. 38) is to identify whether the injured employee has reached a state where his or her condition cannot be improved any further with the current treatment. Website 100 analyses the data point and the output of which will be shown as either Yes or No in the MMI status.

The various documents from which Website 100 identifies this datapoint are:

A. PR-4

B. PR-2

C. Treating Doctors Medical Report

D. D-5021(Doctors first report)

Website 100 uses a combination of different approaches to identify the datapoint.

1) Headnote detection is used to identify the different headnotes from the 30 page long document. Once all the headnotes are identified, Website 100 will search for the headnotes which could have the MMI content and start labelling the text after a matching headnote is found. The labelling ends at the very next headnote, thus being able to label the entire paragraphs in which MMI is being mentioned.

2) The extracted text is then sent to Text Classification model built using AllenNLP where the model is pre-trained with samples of content for each of the categories:
Yes
No

### Training

If the identified data classification seems to be incorrect, the user has an option to train website 100 by clicking the edit button on top and on the training page, the user will have an option to select the correct status(classification) from the dropdown (FIG. 39).

### MPN

Medical Provider Network(MPN) data point (FIG. 40) is to identify whether the treating physician comes under any of the listed medical provider networks and the output of which will be either Yes or No and will be displayed as the status under MPN.

MPN does not have any specific heading to recognize the section and hence website 100 uses the below approaches in classifying MPN:

1) Identified documents are processed through AllenNLP—Q&A model for identifying the specific sentence.

2) The extracted text is then sent to text Classification model using AllenNLP and the same will be classified as the following:
Yes
No

The document from which website 100 identifies this datapoint is referred to as MPN Notice (FIG. 40).

### Training

The training will be similar to Causation and MMI. If the classification seems to be incorrect, the user has an option to train website 100 by clicking the edit button on top and on the training page, the user will have an option to select the correct status(classification) from the dropdown (FIG. 41).

### DOI Reported

Date of Injury(DOI) reported data point is to identify whether the injury has been reported to the employer and if yes, then extract the date.

It is challenging to evaluate the date of injury reported and website 100 uses a combination of multiple approaches to identify and extract the date.

1) Website 100 first detects the form or document which can have the DOI reported data point,

2) Then using google Bert, the most probable sentence which might have the information regarding DOI reported will be fetched

3) The fetched sentence will be then sent to the text Classification model using AllenNLP to classify the DOI reported as Yes or No.

4) If yes, Website 100 uses spaCy to extract the date.

The document from which website 100 identifies this datapoint is AA-NOR.

### Tools Used: Google Bert, AllenNLP, spaCy

### BERT

Bert (Bidirectional Encoder Representations from Transformers) is a natural language processing pre-training approach that can be used on a large body of text. It handles tasks such as entity recognition, part of speech tagging, and question-answering among other natural language processes. Bert helps Google understand natural language text from the Web. BERT helps better understand the nuances and context of words in searches and better match those queries with more relevant results.

### Statuses

The Data Identification stage also have five different statuses:
Not started: When the data identification process has not been started.
In progress: Data identification process is in progress
Pending Review: When the data identification is completed and not reviewed.
Error: If the process failed due to any unexpected error.
Completed: When the data identification process is completed and reviewed.

### Sub-Case Identification

Sub-case Identification is performed to identify all other cases (if any) related to the claimant for which the documents are submitted and analyzed by website 100. Website 100 distinguishes each case with the different date of injury.

Website 100 classifies the injury type into two:
Specific injury
cumulative injury

### Specific Injury

Specific Injuries are a type of injury that happened at a specific time. It could be the result of one incident that causes disability or need for medical treatment.

If the date of injury is reported on a specific day, is considered as a specific injury.

### Cumulative Injury

Cumulative injuries are injuries that happen over a longer period. An injury is cumulative when it includes: “repetitive mentally or physically traumatic activities extending over a period of time, the combined effect of which causes any disability or need for medical treatment.”

In short, if the date of injury is a period rather than a specific date, it is considered cumulative.

Subcases are identified from the documents submitted as it should be considered as a separate case. Website 100 displays the documents that are identified as sub-cases, general documents and the mis-filed documents as shown in FIG. 42 and on clicking which will display the relevant pdf document.

### Analysis and Report

Analysis and Report is the final stage in case file processing. The checklist is cross checked with the data extracted from the document and is validated for formulating the final report.

The main two tabs in Analysis and Report are Checklist analysis and Final Report.

### Checklist Analysis

The checklist analysis tab displays the list of data points identified from the documents uploaded and reviewed.

The data point includes Date Claim Filed, Date of Injury, Injuries Claimed, AOE/COE Report & Witnesses, Personnel File, Index (ISO) Report, Treatment Report, AME/PQME, MMI Status, MPN etc.

This form also has an option to print the details captured and an accordion for detailed view (FIG. 43).

Each of the data points identified will have the following information that will be displayed in detail on expanding the accordion:
Identified Information

All the identified information from the documents will be listed in this section and in the above case (Date claim filed) which will be the checklist item 1, the identified information will be the “Date Claim Filed” info. The source documents from which the data can be captured are:
DWC-1 (claim form), bottom half, section 14
Application for adjudication (proof of service “POS”)
Employer's first report (5020), section 17
Applicant attorney (AA) notice of representation (NOR)
Medical reports

### Checklist Analysis

This section has the list of items to be analyzed at website 100 along with the expected analysis outcome presented to the user.

In the above case the checklist analysis items are:
Legal decision date

Calculate the legal decision date (DD)—It is 90 days from the date claim filed.
BTH Decision date

Calculate the “Breaking the Habit” ® (BTH) DD—It is 30 days and from the date claim filed.

### Info Messages, Action Plans, Suggested Issues

Based on the checklist analysis, expected output could be an info message, action plans and/or suggested issues.

For the above checklist Item 1 (Date claim filed), the info message could be
The number of days left to each of the deadlines (Calculate the number of days left to each DD from the present date).
Display info/action messages if Website 100 cannot find date claim filed
Sources

The documents from which the data point was identified will be listed in this section and the user can view it individually. For this checklist the documents could be the following:
DWC-1 (claim form), bottom half, section 14
Application for adjudication (proof of service “POS”)
Employer's first report (5020), section 17
Applicant attorney (AA) notice of representation (NOR)
Medical reports

### Final Report

In a preferred embodiment Final Report tab displays the final formatted output with all the relevant information and suggested action items. This page also shows the timeline of the case file starting from the date of injury till current day and an option for taking the printout of the final report (FIG. 44).

The final report is sub classified as Case Summary, Info Messages, Suggested Defenses, Action Plans, Documents and witnesses.

Case Summary shows the summary of the case which is again divided as:
Basic Information (Claimant name, SSN, date of birth, address, employer, termination date)
Claim Information (Claim number, Date claim filed, Adjudication number, Claim status, Insured client, Client insurance carrier)
Injury information (Injury type, date of injury, Body parts, start date of injury, End date of injury, Insurance coverage start date, Insurance coverage end date, Causation, MMI status).

Info Messages displays the informational messages generated by Website 100 on analyzing the case file. The Website 100 output includes calculated dates like Breaking the Habit′® Decision Date and legal Decision Date, any missing reports etc.

Suggested Defenses and Action Plans mentions the suggested defense steps the user could take against the case and the set of actions to take care like obtaining any missing report, confirmation of dates etc.

Documents section lists all the documents processed by Website 100 and the list of missing documents. The user will also have an option to download the processed documents.

Witnesses section is for listing the details of any witnesses of the case.

FIG. 45 provides a listing of preferred technology and platforms utilized for the creation and use of website 100. FIG. 46 shows a preferred system architecture.

### User Roles

### Admin

In a preferred embodiment, the admin is the user who has all the permission and access to all modules in the application.

Main modules available for admin are:
Open a new case file

Users will be able to open a new case file in the system.
View Dashboard

Dashboard displays an overview of different stages in the case file.
Upload files

Users will be able to upload relevant documents related to a case file.
Review & Edit Documents

Users will be able to review and edit the documents identified from the uploaded files.
Review & Edit Data Points

Users will be able to review and edit the different data points extracted from the different documents.
View & print Checklist Analysis and Final Report

Users will be able to view the analysis that Website 100 has generated based on the Breaking The Habit strategy

### The Trainer

The Trainer has the ability to train the application by providing corrections while editing the output in every stage.

### Client Users

Client user roles are for users who use and access website 100. Client users also have access to most of the modules other than the application administration module and the user management.

### Third Party Integrations

### RabbitMQ

RabbitMQ is an open-source message-broker software (sometimes called message-oriented middleware) that originally implemented the Advanced Message Queuing Protocol (AMQP) and has since been extended with a plug-in architecture to support Streaming Text Oriented Messaging Protocol (STOMP), Message Queuing Telemetry Transport (MQTT), and other protocols.

The RabbitMQ server program is written in the Erlang programming language and is built on the Open Telecom Platform framework for clustering and failover. Client libraries to interface with the broker are available for all major programming languages.

### Box Detection Further Disclosure

As stated above, the Box detection method is used to identify whether a form or document has boxes within and to extract data from each box separately.

Unlike a plain text document, some of the documents could be of tables and forms with different height and width of rows and columns which makes it difficult for the OCR to detect the data since it reads the data sequentially and generates inappropriate output. In order to overcome the limitation of OCR tools while extracting text from a form-based document, website 100 is programmed to use a method called Box detection and data extraction.

The Box detection method is used to identify whether a document has boxes/columns in it and identify each box separately.

Website 100 follows two different approaches depending on the document type to overcome the limitations of available tools and they are:

A) Box identification using Tensorflow Object detection.

B) Box identification using OpenCV.

### Box Identification Using Tensorflow Object Detection

This approach is used for forms like Doctor's first report which has been identified and classified using document classification. In this method, boxes are identified inside a document using TensorFlow object detection with the help of pre-trained data set.

Technical Workflow of Box identification using TensorFlow

The steps in box identification using TensorFlow are outlined in the flowchart shown in FIG. 47.

1) Document pre-processing:

Document pre-processing is the first step in document identification which includes:
Uploading of scanned pdf documents.
Conversions of pdf to image.
Document classification using Keras.

2) Document type classification and section identification:

Once the document is identified and classified using Keras, documents such as Doctor's first report will be further classified into Type1, type2, and Type3 based on the structure of the document using HED edge detection algorithm and TensorFlow object detection (see above discussion). All the Type1 documents are then processed for Box detection and data extraction using this approach.

3) Object detection using TensorFlow:

Object detection method using TensorFlow is then used for identifying the boxes within the document and mark them with the coordinates. FIG. 48 shows a screenshot of a sample Doctor's first report and a section selected from it for demonstration purpose.

After identifying the document and the section from which the data is to be extracted, the image is sent to TensorFlow for identifying the Boxes (Value) and the corresponding Key from the document. TensorFlow is pre-trained to identify the boxes in this type of form.

FIG. 49 shows the demonstration of an image after identifying the boxes and are represented using the boxes 903. The output of TensorFlow object detection will be the coordinates of the corresponding boxes.

4) Crop and Merge the marked images:

The marked boxes are cropped as separate images using the coordinates received from the TensorFlow object detection. The Cropped images are merged vertically to form a new image before sending it to Google Vision for text extraction (FIG. 50-51).

5) Text extraction using Google Vision OCR

The temporary image created will be sent for text extraction using Google Vision OCR. The output will be the text extracted from the image (FIG. 52).

### Box Identification Using OpenCV

This approach is used for forms like Employer's first report, Doctor's first report(Type 2) etc. which has been identified and classified using document classification. Since the documents are scanned images of the original document, there are high chances that these forms have missing/incomplete lines(both vertical and horizontal) which makes the object(Box) detection difficult through TensorFlow and hence a different approach is used to identify the Boxes inside a form.

### Technical Workflow of Box Identification Using OpenCV

The steps in Box identification using OpenCV are outlined by reference to the flowchart shown in FIG. 53.

1) Document pre-processing:

Document preprocessing is the first step in document identification, which includes:
Uploading of scanned pdf documents.
Conversions of pdf to image.
Document classification using Keras.
Section Identification

FIG. 54 shows a Sample Employer's first report document.

2) Identify all the vertical lines using opencv:

After identifying the right documents, the first step is to identify the vertical lines using the openCV library and mark those using the coordinates returned. FIG. 55 shows the document after identifying and marking the vertical lines.

3) Identify all horizontal lines lines using openCV:

Next step is to identify the horizontal lines in the document using the openCV library and mark it with the coordinates returned. Once the horizontal lines are identified, the lines will be extended so that there are no missing/incomplete lines in forming a box.

FIG. 56 shows a Sample form with incomplete line. FIG. 57 shows a Sample form after extending the horizontal line. FIG. 58 shows the Document after identifying and making the horizontal lines.

5) Crop and Merge the marked images:

The marked boxes will be cropped as separate images using the coordinates received from OpenCV. The Cropped images will be merged vertically to form a new image before sending it to Google Vision for text extraction. FIG. 59 shows a temporary image created by vertically merging the boxes as an input for OCR.

6) Text extraction using Google Vision OCR

The temporary image created will be sent for text extraction using Google Vision OCR. The output will be the text extracted from the image (FIG. 60).

### Alternate Solutions Analyzed

Google Vision
Amazon Textract
IBM Smart Document Understanding

### Google Vision OCR

Cloud Vision API allows is an AI service provided by Google which helps in reading text (printed or handwritten) from an image using its powerful Optical Character Recognition (OCR).

### Limitation

Even though google vision is a powerful OCR tool, we were not getting the expected result while extracting text from documents or forms with uneven rows and columns. Since Google Vision OCR reads randomly by assigning boxes in the image and there are possibilities that it returns text in a different sequence from the original text sequence. FIG. 61 shows a Sample screenshot showing how Google extracts text from a form.

FIG. 61 shows an example for a form-based document where the date of birth is followed by the employee name instead of actual date and the phone number field shows address as the corresponding value which is unrelated.

### Amazon Textract

Amazon Textract is a service that automatically extracts text and data from scanned documents as key-value pairs. Detected selection elements are returned as Block objects in the responses from AnalyzeDocument and GetDocumentAnalysis.

Block objects with the type KEY_VALUE_SET are the containers for KEY or VALUE Block objects that store information about linked text items detected in a document.

For documents with structured data, the Amazon Textract Document Analysis API can be used to extract text, forms and tables.

Limitations of Amazon Textract
Detection accuracy was low
Was not able to detect required data like date, address
Data accuracy was low.
Documents can be rotated a maximum of +/−10% from the vertical axis. Text can be text aligned horizontally within the document.
Amazon Textract only supports English text detection.
Amazon Textract doesn't support the detection of handwriting.

### IBM Smart Document Understanding

Smart Document Understanding (SDU) trains IBM Watson Discovery to extract custom fields in documents. Customizing how documents are indexed into Discovery improves the answers that application returns.

With SDU, fields can be annotated within the documents to train custom conversion models. As you annotate, Watson is learning and starts to predict annotations. SDU models can be exported and used on other collections.

### Limitations of IBM SDU

Detection accuracy was low
Was not able to detect required data like date, address
Data accuracy was low.

### Headnote Detection further Disclosure

Headnote detection is a method used for identifying the headnotes separately in documents. Some documents will classify the data under different sections separated by headings and it is crucial to identify the headnotes for data classification and identification.

### Solution Identified

Tensor flow Object Detection API is used for detecting headings from the image document and the model being used is Faster R-CNN Inception v2 architecture.

The height and width of characters and are compared to other characters to differentiate the headnote and non-headnotes. A word is considered as a headnote if the word matches the predefined heading criteria. Website 100 can be trained by marking the headnote and capturing the properties such as height, width, Xmin, Xmax, Ymin, Ymax will be saved as a .csv file for reference.

### Technical Workflow of Headnote Detection

The steps of identifying headnotes are shown in FIG. 62.

1) Document pre-processing:

Document preprocessing is the first step in document identification, which includes:
Uploading of scanned pdf documents.
Conversions of pdf to image.
Document classification using Keras.
Section Identification.

FIG. 63 shows a sample document identified and classified for headnote detection.

2) Headnote identification using Tensorflow object detection:

TensorFlow object detection is used for headnote detection using a pre-trained data set. Input to it will be the image and the data set and the object detection algorithm gives the output as marked headnotes with the starting position(x,y) and the height and width of the heading to mark it as a bounding box.

FIG. 64 shows a Sample document showing all the headnotes identified and marked.

3) Crop and Merge the marked images:

The marked boxes will be cropped as separate images using the coordinates received from TensorFlow object detection. The Cropped images will be then merged vertically to form a new image before sending it to Google Vision for text extraction (FIG. 65). FIG. 65 shows a temporary image created by merging the headnotes vertically as input for OCR.

4) Text extraction using Google Vision OCR

The temporary image created will be sent for text extraction using Google Vision OCR. The output (FIG. 66) will be the text extracted from the image which is basically the identified headnotes in the document.

### Alternate Solutions Analyzed

### Google Vision OCR

Cloud Vision API allows is an AI service provided by Google which helps in reading text (printed or handwritten) from an image using its powerful Optical Character Recognition (OCR).

Limitation:

Google Vision is a powerful optical character recognition tool and can be used for text extraction but it was difficult to distinguish a normal text with headings.

### Image AI

Image AI is a python library for image recognition, Image AI is an Easy to use Computer Vision Library for state-of-the-art Artificial Intelligence.

Limitation:
No customization
Less prediction

### Checkbox Detection Further Disclosure

Some of the documents that are uploaded have checkboxes within them and most of them are required data for preparing the final report and to provide a solution. Object detection method is used to detect the checkboxes in a document and to identify whether the checkbox is checked or unchecked. It is difficult to detect them from a scanned document and to recognize whether it is checked or not.

### Solution

Website 100 uses object detection methods for identifying the checkbox using TensorFlow. Website 100 is trained to identify more different types of checkboxes.

The various types of checkboxes that are identified are shown in FIG. 27.

As stated above, when a checkbox is detected as marked, website 100 replaces the marked checkbox with ‘+Y+’ or ‘+N+’ and a column will be created along with the associated text and will be sent for text extraction. FIG. 28 shows a flowchart depicting the utilization of checkbox detection.

### Steps in Checkbox Detection (FIG. 28)

1) Document pre-processing:

Document preprocessing is the first step of document identification which includes:
Uploading of scanned pdf documents.
Conversions of pdf to image.
Document classification using Keras.
Section Identification.

FIG. 67 shows a screenshot depicting a Doctor's first report which has been cropped for demonstration purpose.

2) Detect marked checkboxes:

With the help of a pre-trained object detection method built using Tensorflow, website 100 identifies the marked checkboxes as Yes or No (FIG. 68).

3) Replaces the checkboxes with +Y+ or +N+

After identifying the marked checkboxes as either Yes or No, website 100 replaces them with +Y+ for Yes and +N+ for No so that on extracting the text using OCR, the corresponding value can be extracted (FIG. 69).

4) Box detection and text extraction

Object detection methods using TensorFlow or OpenCV will be used for identifying the boxes within the document and mark them with the identified coordinates and the marked image is then cropped and merged vertically to form a temporary image and which is sent to OCR(Google Vision for text extraction). Refer Box detection for additional details.

### Alternate Solutions Analyzed

### Amazon Textract

Amazon Textract is a service that automatically extracts text and data from scanned documents as key-value pairs. Detected selection elements are returned as Block objects in the responses from AnalyzeDocument and GetDocumentAnalysis.

Block objects with the type KEY_VALUE_SET are the containers for KEY or VALUE Block objects that store information about linked text items detected in a document.

Limitations of Amazon Textract:
Detection accuracy was low and not reliable with scanned documents.
Data accuracy was low.
Documents can be rotated a maximum of +/−10% from the vertical axis.
Amazon Textract doesn't support the detection of handwriting.

### Edge Detection and Document Type Classification

There are scenarios where Website 100 receives documents of the same type with different structure like the document “Doctor's First Report”. Some of them will be of forms while the other could be just plain text and hence different approaches should be followed to identify and extract data from it. In Order to sub classify this type of document, Website 100 uses a method called Edge detection and document type classification.

Edge detection is an image processing technique for finding the boundaries of objects within images. It works by detecting discontinuities in brightness. Edge detection is used for image segmentation and data extraction.

HED (Holistically-Nested Edge Detection) algorithm is used for edge detection and object classification using TensorFlow for different document type classification. Currently it is being used for Doctor's first report to differentiate the three different types of form (Type1, Type2 and Type3).

When tried with normal image classification using TensorFlow image classification, the prediction was low and was not reliable with document classification and hence, it is preferable to use HED image conversion using HED algorithm and later classify the image using TensorFlow image classification.

FIG. 70 shows the steps in Document type classification using HED.

1) Document pre-processing:

Document preprocessing is the first step Website 100 document identification which includes:
Uploading of scanned pdf documents.
Conversions of pdf to image.
Document classification using Keras.
Section Identification.

2) Convert image using HED algorithm:

Website 100 uses HED (Holistically-Nested Edge Detection) algorithm for edge detection and converts the image to HED image.

FIG. 71 shows a sample image document after HED conversion.

3) Type identification using TensorFlow image classification

The HED image is then sent to the TensorFlow image classification algorithm for classifying the image or document type as Type1 (FIG. 29), Type2 (FIG. 30) and Type3 (FIG. 31). TensorFlow image classification is pre-trained to identify the images separately.

The three different classifications are:

Type 1 (FIG. 29): Document contains forms and where the field name is outside the box and the value is inside the box.

Type 2: (FIG. 30) Document contains forms and both the field name and the value is inside the box.

Type 3: (FIG. 31) Documents without forms and contains only plain text.

4) Further image processing and data extraction.

Once the document is classified, it will be further processed based on the type identified.

Type1 image document will be processed for box detection and OCR for text extraction, Type2 image document will be sent for checkbox detection, box detection and OCR for text extraction and Type3 image document will be directly sent for text extraction.

### Alternate Solutions Analyzed

### TensorFlow Image Classification

The TensorFlow image classification model is trained to recognize various types of images and to predict what an image represents. It uses a pre-trained and optimized model to identify hundreds of classes of objects, including people, activities, animals, plants, and places etc.

Limitations:
Less prediction as the detection accuracy was low for scanned documents
Not reliable with similar types of scanned documents.

### Amazon Recognition

Amazon Recognition can be used to analyze image and video in applications using proven, highly scalable, deep learning technology that requires no machine learning expertise. Amazon Recognition can be used to identify objects, people, text, scenes, and activities in images and videos, as well as detect any inappropriate content.

Limitations:
Expensive
Less efficiency with document classification
Time consuming

### Pre-Training the Object Detection Data Set

This training is different from the way in which other AI modules in Website 100 are trained. The AI modules give an option to the users of the application to train the AI algorithms by correcting the prediction output. However, in the case of object detection, this option is not given to the user at the moment in the Website 100 application.

In this case, the ‘Object detection’ algorithm is pre-trained with multiple samples to ensure accurate prediction. This method of training is used in the features where website 100 uses the below methods:
Box detection
Headnote detection
Checkbox detection
Form type classification

### Steps for the TensorFlow Object Detection Training

### Annotating Images

Image annotation is the task of manually labelling images, usually by using bounding boxes, which are imaginary boxes drawn on an image. The use of Bounding Boxes in Image Annotation is for Object Detection. Bounding boxes is an image annotation method used in machine learning and deep learning. Using bounding boxes annotators can outline the object in a box as per the machine learning project requirements.

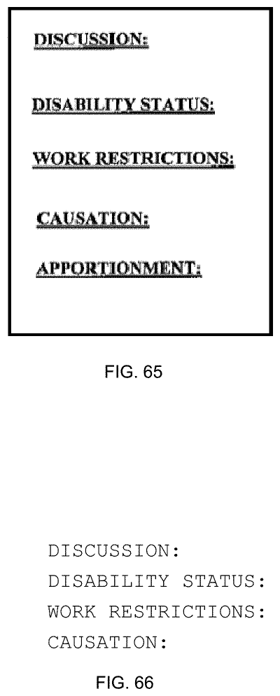

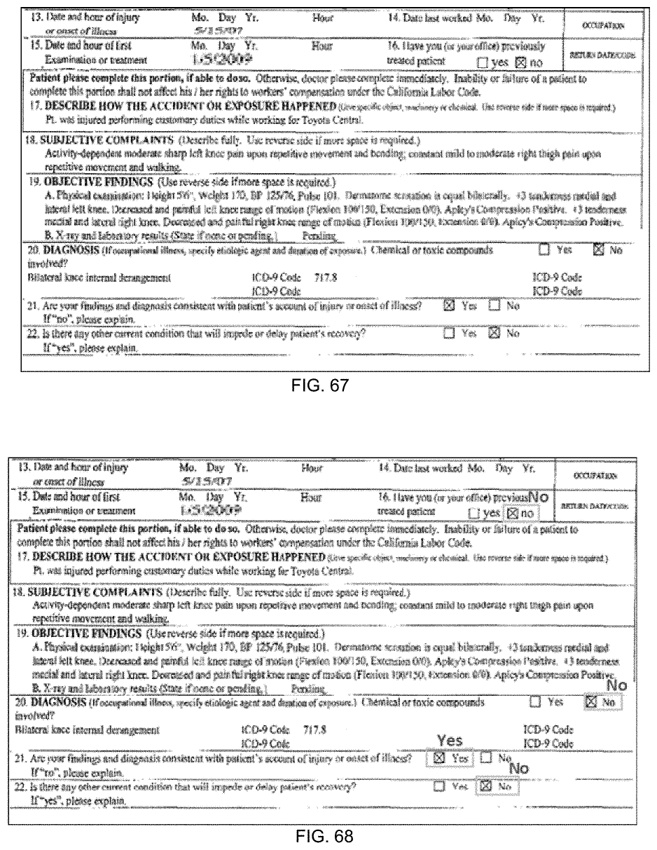

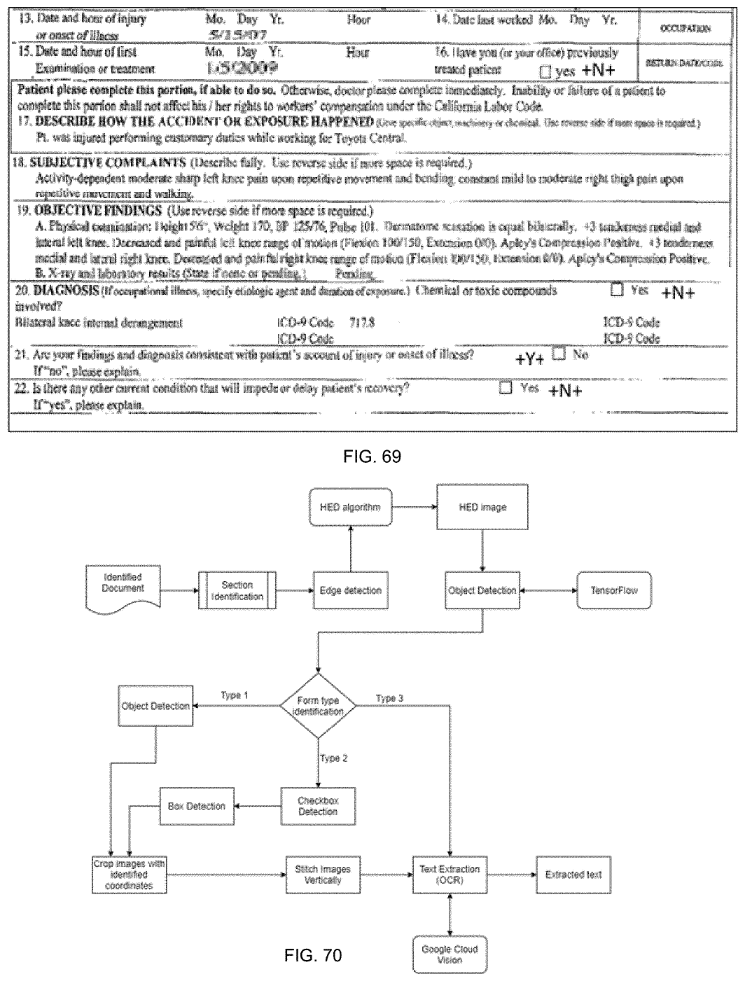

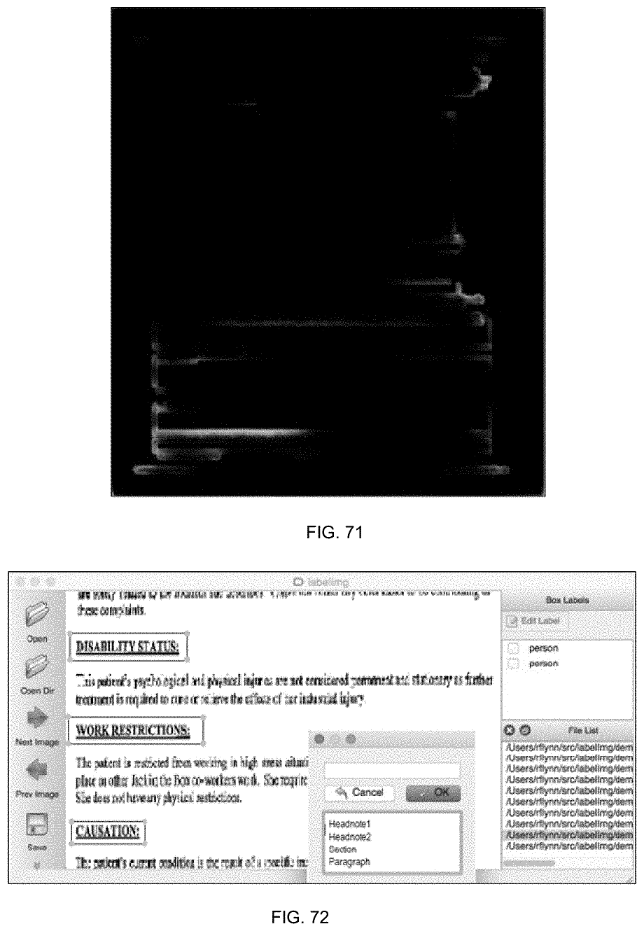

To annotate an image, the labelImg package will be used (FIG. 72). The image is sent to the annotation tool and mark the objects(box, marked checkbox, headings etc) that have to be trained manually. The more images trained the more accurate the prediction.

LabelImg is a graphical image annotation tool. It is written in Python and uses Qt for its graphical interface.

The output of the tool will be an annotation xml file which contains the details of the annotated image like Xmax, Ymax, Xmin, Ymin.

### Creating TensorFlow Records

The generated annotations and the dataset have to be grouped into the desired training and testing subsets and the annotations has to be converted into TFRecord(TensorFlow Record) format.
Converting the individual *.xml files to a unified *.csv file for each dataset.
Converting the *.csv files of each dataset to *.record files (TFRecord format).

### Training the TensorFlow Object Detection Model

The .csv and the image has to be sent as input for training and trains the model with the TFRecord and the model file output will be in .pb format which will be then stored locally and will be used for object detection.

Although the above-preferred embodiments have been described with specificity, persons skilled in this art will recognize that many changes to the specific embodiments disclosed above could be made without departing from the spirit of the invention. For example, it should be understood that the procedures and methods discussed above in relation to box detection, headnote detection, checkbox detection, edge detection and document type classification can easily be applied to forms and documents of any subject matter. Therefore, the attached claims and their legal equivalents should determine the scope of the invention.

What is claimed is:

1. A system for automatically analyzing information related to a workers' compensation claim and for providing a case analysis report, said system comprising:
A. at least one licensed user computer, said licensed user computer programmed to:
a. upload via a computer network documents and data related to a workers' compensation claim,
b. download via said computer network said case analysis report comprising analysis and recommended plan of action regarding said workers' compensation claim
B. at least one server computer accessible via said computer network, said at least one server computer programmed to receive said documents and data related to a workers' compensation claim, said at least one server computer comprising programming for:
a. a pdf/image text extractor for receiving said uploaded documents and data from said licensed user computer
b. a checklist data provider for providing a criteria checklist to be compared against said documents and data,
c. an information identifier for comparing said checklist to said uploaded documents and data to generate identified text,
d. a natural language processor for receiving said identified text and generating text with maximum probability score,
e. an issue identifier for receiving said text with maximum probability score and for generating possible issues,
f. an issue analyzer for receiving said possible issues and for generating an analyzed decision and said case analysis report, and
g. a decision data model for receiving said analyzed decision and for storing said analyzed decision for future analysis.

2. The system as in claim 1, wherein said at least one licensed computer is a laptop computer.

3. The system as in claim 1, wherein said at least one licensed computer is a cell phone.

4. The system as in claim 1, wherein said at least on licensed computer is an iPad®.

5. The system as in claim 1, wherein said at least one licensed computer is owned by a business carrying workers' compensation insurance.

6. The system as in claim 1, wherein said at least one licensed computer is owned by third party administrator.

7. The system as in claim 1, wherein said at least one server computer further comprises programming for box detection.

8. The system as in claim 1, wherein said at least one server computer further comprises programming for headnote detection.

9. The system as in claim 1, wherein said at least one server computer further comprises programming for checkbox detection.

10. The system as in claim 1, wherein said at least one server computer further comprises programming for edge detection and document type classification.

11. A method for automatically analyzing information related to a workers' compensation claim and for providing a case analysis report, said method comprising the steps of:
A. utilizing at least one licensed user computer to upload via a computer network documents and data related to a workers' compensation claim,
B. utilizing at least one server computer to receive said documents and data related to a workers' compensation claim, said at least one server computer comprising programming for:
a. a pdf/image text extractor for receiving said uploaded documents and data from said licensed user computer
b. a checklist data provider for providing a criteria checklist to be compared against said documents and data,
c. an information identifier for comparing said checklist to said uploaded documents and data to generate identified text,
d. a natural language processor for receiving said identified text and generating text with maximum probability score,
e. an issue identifier for receiving said text with maximum probability score and for generating possible issues,
f. an issue analyzer for receiving said possible issues and for generating an analyzed decision and said case analysis report, and
g. a decision data model for receiving said analyzed decision and for storing said analyzed decision for future analysis, and
C. utilizing said at least one licensed computer to download via said computer network said case analysis report comprising analysis and recommended plan of action regarding said workers' compensation claim.

12. The method as in claim 11, wherein said at least one licensed computer is a laptop computer.

13. The method as in claim 11, wherein said at least one licensed computer is a cell phone.

14. The method as in claim 11, wherein said at least on licensed computer is an iPad®.

15. The method as in claim 11, wherein said at least one licensed computer is owned by a business carrying workers' compensation insurance.

16. The method as in claim 11, wherein said at least one licensed computer is owned by third party administrator.

17. The method as in claim 11, wherein said at least one server computer further comprises programming for box detection.

18. The method as in claim 11, wherein said at least one server computer further comprises programming for headnote detection.

19. The method as in claim 11, wherein said at least one server computer further comprises programming for checkbox detection.

20. The method as in claim 11, wherein said at least one server computer further comprises programming for edge detection and document type classification.
